(19) United States
(12) Patent Application Publication
(10) Pub. No.: US 2016/0237804 A1
(43) Pub. Date: Aug. 18, 2016

(54) STRESS ENGINEERING ASSESSMENT OF RISERS AND RISER STRINGS

(71) Applicants: Stylianos Papadimitriou, HOUSTON, TX (US); WANDA PAPADIMITRIOU, HOUSTON, TX (US)

(72) Inventors: Stylianos Papadimitriou, HOUSTON, TX (US); WANDA PAPADIMITRIOU, HOUSTON, TX (US)

(21) Appl. No.: 15/136,282

(22) Filed: Apr. 22, 2016

Related U.S. Application Data
(63) Continuation-in-part of application No. 14/095,085, filed on Dec. 3, 2013, now Pat. No. 9,322,763.
Application No. 14/095,085 is a continuation-in-part of application No. 13/304,136, filed on Nov. 23, 2011, now Pat. No. 8,831,894.
Application No. 13/304,136 is a continuation-in-part of application No. 11/769,216, filed on Jun. 27, 2007, now Pat. No. 8,086,425.
Application No. 11/769,216 is a division of application No. 11/772,357, filed on Jul. 2, 2007, now Pat. No. 8,050,874.
Application No. 11/772,357 is a continuation-in-part of application No. 11/769,216, filed on Jun. 27, 2007, now Pat. No. 8,086,425.
Application No. 11/769,216 is a continuation-in-part of application No. 10/867,004, filed on Jun. 14, 2004, now Pat. No. 7,240,010.
Application No. 11/769,216 is a continuation-in-part of application No. 10/867,004, filed on Jun. 14, 2004, now Pat. No. 7,240,010.
Application No. 10/867,004 is a continuation-in-part of application No. 11/743,550, filed on May 2, 2007, now Pat. No. 7,403,871.
Application No. 11/743,550 is a continuation of application No. 11/079,745, filed on Mar. 14, 2005, now Pat. No. 7,231,320.
Application No. 11/079,745 is a continuation-in-part of application No. 10/995,692, filed on Nov. 22, 2004, now Pat. No. 7,155,369.

(51) Int. Cl. E21B 47/00; G06F 17/50; E21B 17/01

(52) U.S. Cl. CPC E21B 47/0006; E21B 17/01; G06F 17/5009; E21B 33/064

(57) ABSTRACT

Riser stress-engineering-assessment equipment to verify the integrity and the in-deployment-integrity of a riser string by knowing the status, details and location of each riser joint and by monitoring the deployment parameters. When the failure risk exceeds an acceptable level, the equipment activates a local and/or a remote alarm using voice, sound and lights. The system comprises a computer with communication means, a material properties and geometry detection system, a data acquisition system acquiring deployment and other parameters, a database comprising of riser historical data and captured expert knowledge, a failure-criteria calculation to calculate maximum-stresses under different loads and the combined effects of the different loads to determine if the riser string is still fit-for-deployment.

### TECHNICAL FIELD

The invention is an autonomous system approach to risk management through continuous riser stress-engineering-assessment. The system/method verifies the integrity of a riser joint and the in-deployment-integrity of a riser string by knowing the status, details and location of each riser joint and by monitoring the deployment parameters. When the failure risk exceeds an acceptable level, riser stress-engineering-assessment equipment activates at least one alarm using voice, sound and lights.

### BACKGROUND OF THE INVENTION

Components are made from materials and are typically assembled to sub-systems which in turn are assembled to complex systems. Complex systems are assembled using processes and often they function within the envelop of a process. As is known in the art, materials are selected for use based on criteria including minimum strength requirements, useable life and anticipated normal wear. The list of typical materials and systems includes, but is not limited to, aircraft, beam, bridge, blowout preventer, BOP, boiler, cable, casing, chain, chiller, coiled tubing (herein after referred to as “CT”), chemical plant, column, composite, compressor, coupling, crane, drill pipe (herein after referred to as “DP”), drilling rig, enclosure, engine, fastener, flywheel, frame, gear, gear box, generator, girder, helicopter, hose, marine drilling and production Riser (herein after referred to as “Riser”), metal goods, oil country tubular goods (herein after referred to as “OCTG”), pipeline, piston, power plant, propeller, pump, rail, refinery, rod, rolling stoke, sea going vessel, service rig, storage tank, structure, sucker rod (herein after referred to as “SR”), tensioner, train, transmission, trusses, tubing, turbine, vehicle, vessel, wheel, workover rig, components of the above, combinations of the above, and similar items, (herein after referred to as “Material-Under-Assessment” or “MUA”). “MUA of interest” is also referred to as “MUA”.

During its useful life, MUA deteriorates and/or is weakened and/or is deformed by external events such as mechanical and/or chemical actions arising from the type of application, environment, repeated usage, handling, hurricanes, earthquakes, ocean currents, pressure, waves, storage, temperature, transportation, and the like; thus, raising safety, operational, functionality, and serviceability issues. A non-limiting list of the loads the MUA may endure during its life involves one or more of bending, buckling, compression, cyclic loading, deflection, deformation, dynamic linking, dynamic loading, eccentricity, eccentric loading, elastic deformation, energy absorption, feature growth, feature morphology migration, feature propagation, flexing, heave, impulse, loading, misalignment, moments, offset, oscillation, plastic deformation, propagation, pulsation, pulsating load, shear, static loading, strain, stress, tension, thermal loading, torsion, twisting, vibration, analytical components of the above, relative components of the above, linear combinations thereof, non-linear combinations thereof and similar items, (herein after referred to as “Loads”).

Marine drilling risers, catenary risers, flexible risers and production risers are hereinafter referred to as “Riser”. Risers provide a conduit for the transfer of materials, such as drilling and production fluids and gases, to and from the seafloor equipment, such as a Blowout Preventer, hereinafter referred to as “BOP”, to the surface floating platform.

Multi-tubulars comprise tubular arrangement of multiple tubes running in parallel. Risers are multi-tubulars along with umbelicals. However, umbelicals may be analyzed as one tube whereas the main tube of the riser is the main load bearing structure.

A Riser joint may comprise of a single or more typically multiple pipes in parallel that are selected for use based on minimum material strength requirements. Each Riser joint is designed to withstand a range of operation loads, hereinafter after referred to as “Loads”. A failure occurs when the stresses due to the deployment Loads exceed the actual Riser strength. It is reasonable therefore to expect that the applicable Standards and Recommended Practices would discuss and set allowable stresses limits and/or maximum allowable Loads.

### REFERENCES

American Petroleum Institute (API) RP 16Q: Recommended Practice for Design, Selection, Operation and Maintenance of Marine Drilling Riser Systems
API Specification 16F: Specification for Marine Drilling Riser Equipment
American Society of Mechanical Engineers (ASME) B31.4
API 579-1/ASME FFS-1: Fitness-for-Service
Det Norske Veritas (DNV): DNV-OS-F201 Offshore Standards
DNV-F206: Riser Integrity Management
DNV-OSS-302: Offshore Riser Systems
DNV-RP-G103: Non-Intrusive Inspection
American Bureau of Shipping (ABS): Guide for the Certification of Drilling Systems
ABS: Guide for Building and Classing Subsea Riser Systems
Atlantic Margin Joint Industry Group (AMJIG): Deep Water Drilling Riser Integrity Management Guidelines.
Theory of Elasticity S. P. Timoshenko, J. N. Goodier
ROARK'S Formulas for Stress and Strain
Pertersen Stress Concentration Factors

Review of Standards and Recommended Practices

API RP 16Q Section 3: RISER RESPONSE ANALYSIS “This section applies equally to the design of a new riser system or the site specific evaluation of an existing riser system. Riser analysis should be performed for a range of environmental and operational parameters.”

API RP 16Q Table 3.1: Lists maximum operating and design stresses factors and “[3] All stresses are calculated according to von Mises stress failure criterion”.

API 16F Section 5.4: “The analysis shall provide peak stresses and shall include effects of wear, corrosion, friction and manufacturing tolerances” 3.74 Stress Amplification Factor (SCF): “The factor is used to account for the increase in the stresses caused by geometric stress amplifiers that occur in riser components”.

ASME B31.4 402 Calculation of stresses: “Circumferential, longitudinal, shear, and equivalent stresses shall be considered . . . ” “Calculations shall take into account stress intensification factors . . . ” Table 402.1-1 lists “stress intensification factors”.

ABS 9.1: “The riser is to be so designed that the maximum stress intensity for the operating modes, as described in API RP 16Q, is not exceeded”

AMJIG A.1.2: “Assessment of pipe strength is based on the von Mises combined stress criterion” A1.2.1 Riser Stresses: “API-RP-16Q recommends a maximum allowable stress factor for drilling operations of 0.67”.

DNV-RP-F204: Riser Fatigue Appendix A.

DNV-F206 10.2.2: Condition Based Maintenance “This maintenance strategy can be used when it is possible to observe some kind of equipment degradation”.

DNV-OSS-302: API RP 16Q is applicable. 108: “Establishment of components strength in terms of maximum applicable external loads/deformations”

API 579-1/ASME FFS-1 G.1.2. “When conducting a FFS assessment it is very important to determine the cause(s) of the damage or deterioration”.

Review of Non-Destructive-Inspection

The concepts of modern Non-Destructive-Inspection (hereinafter referred to as “NDI”) were established in the 1920s. Modern day NDI units often use a similar design concept as the U.S. Pat. No. 1,823,810 and the exact same sensors and configuration as found in U.S. Pat. No. 2,685,672 FIGS. 5 and 6. The vacuum tube amplifier of U.S. Pat. No. 1,823,810 is replaced with a solid-state amplifier and the readout meter is replaced by a computer with a colorful display. A few have replaced the coil sensors of U.S. Pat. No. 2,685,672 FIGS. 5 and 6 with Hall probes. None of this repackaging has improved the overall capabilities of modern NDI as the U.S. Pat. No. 2,685,672 single sensor per area comingles all imperfection signals into one signal resulting in what may be called a one-dimensional NDI, herein referred to as “1D-NDI”. Notice that the 1D-NDI classification also applies to eddy-current, radiation, ultrasonic, similar systems and combinations thereof. Some combine different 1D-NDI techniques in-line resulting in a system with two or more 1D inspection signals that are not related in form, kind, space and time and thus, they cannot be used to solve a system of equations.

The 1D-NDI signal is insufficient to solve the system of equations to “determine the cause(s) of the damage or deterioration” per API 579-1/ASME FFS-1 and to identify the “geometric stress amplifiers that occur in riser components” per API 16F. Therefore, and as opposed to RiserSEA as discussed hereinafter, 1D-NDI data is unrelated to the as-is Riser strength, fitness-for-service (herein referred to as “FFS”) and remaining-useful-life (herein referred to as “RUL”) other than an occasional end-of-life statement.

It should be expected that the Lack-of-Knowledge about the MUA Features results in “false indications” or “false calls” whereby the 1D-NDI signal (1D-NDI flag) is not associated with any Feature, resulting in wasted verification crew man-hours and reduced productivity. In order to improve productivity, 1D-NDI employs threshold(s) to eliminate the material signature, the low amplitude signals that are commonly referred to as “grass”. Fatigue gives rise to low amplitude signals and therefore, fatigue signals are eliminated from the 1D-NDI traces as a standard procedure. For example, 1D-NDI equipment that is configured to comply with T.H. Hill DS-1, will never detect drill pipe fatigue build-up regardless of how often drill pipe undergoes DS-1 type of inspection.

The “false calls” in U.S. Pat. No. 6,594,591 is the result of 1D-NDI “not knowing by any detail” the MUA Feature, not even knowing if the signal corresponds to a Feature much less been capable of “connecting or associating the feature with known definitions” that allow the calculation of an FFS and/or RULE. US Patent Application 2004/0225474 describes the same problem in [0004] “A significant impediment to NDE inspections in the field (as opposed to depot) and to onboard diagnostics and prognostics is the potential for excessive false indications that directly impact readiness”. In other words, 1D-NDI cannot be deployed in the field or onboard an aircraft because of the excessive number of 1D-NDI “false indications” requiring the human intervention of at least one verification crew.

It should be understood that all the means and methods improvised to reduce the 1D-NDI “false indications” or “false calls” are simply band aids to the underline problem of insufficient number of sensors and signal processing to solve the multidimensional MUA problem (the system of equations) of detecting, identifying and recognizing MUA Features and calculating an FFS and/or a RULE as the present invention does.

Furthermore, today's NDI standards, like the drill pipe DS-1, discuss Fatigue extensively and then specify an 1 D-NDI unit setup that eliminates any Fatigue signals through thresholds to improve the “signal to noise ratio”, just like in the 1920s U.S. Pat. No. 1,823,810 variable grid bias. However, the “noise” also contains metallurgy and Fatigue signals in addition to the sensor ride chatter. Therefore, modern day repackaging of the 1920s 1D-NDI means and methods did not improve the overall 1D-NDI performance. Because of the signal commingling and the limited dynamic range, 1D-NDI cannot detect many of the dangerous imperfections early on, such as fatigue, and has a limited operational range for pipe size, configuration, wall thickness, types of imperfections, inspection speed, sampling rate and similar items while it still relies on the manual intervention of a verification-crew to locate and identify the source of the 1D-NDI signal. As opposed to the RiserSEA affirmative verification of the as-is Riser status, 1D-NDI verifies that it did not detect the few late-life defects within its capabilities.

As opposed to inspection, Assessment is an affirmative process that relies on a sufficient number of good quality specific data to judge and confirm. FFS and RULE are the results of an Assessment.

It would then be the responsibility of whoever performs the Assessment to define the good quality inspection(s), scope and techniques including the number and type of specific data to facilitate the Assessment. Inspection therefore is a very small part of an Assessment process and it is well defined only when it is part of an Assessment process. Inspection is not a substitute for an Assessment. Many disasters root-cause can be traced to this misunderstanding alone; where inspection, such as 1D-NDI, is used as a substitute for Assessment.

It should further be understood that Assessment preferably examines and evaluates, as close as possible, 100% of the MUA for 100% of Features and declare the MUA fit for service only after the Features impact upon the MUA have been evaluated under specific knowledge and rules that include, but not limited, to the definition of the deployment “service” or “purpose”. Inspection, such as 1 D-NDI, inherently cannot fulfill that role. Marine Drilling Risers are an example of the difference between Assessment and inspection.

Risers connect the drillship to the seafloor BOP and therefore are a very critical component of the offshore drilling operation. Based on the API RP-579 Fitness-For-Service recommendations, the Riser Assessment of the main tube alone should be based on about 30,000 Wall-Thickness readings. From the commercial literature, the Riser inspection of U.S. Pat. No. 6,904,818 acquires about 180 Wall-Thickness readings and yet, it does fulfill the “annual inspection” letter of the Law although more than 99% of the Riser condition is still unknown after this inspection.

Although API RP-579 lists some of the MUA specific data required to facilitate an Assessment it fails to provide means to obtaining the MUA specific data that lead to an Assessment as it only focuses on how difficult it is obtain such data (sufficient number of good quality data) with 1D-NDI. Attaining detailed MUA condition knowledge and the associated specific data through manual means is prohibitive both financially and time wise as it involves the employment of a number of multidiscipline experts, laboratories and equipment.

It is desirable therefore to provide to the industry automatic means and methods to facilitate an MUA condition based maintenance program through an Assessment and preferably, through frequent Assessments to facilitate a constant-vigilance maintenance program, especially for high-reliability safety-critical equipment, systems and processes with minimum amount of human intervention.

Riser 1D-NDI Analysis

Riser pipes fall well outside the inspection capabilities of 1D-NDI. Furthermore, the primary concern of the Riser manufacturers (herein referred to as “Riser-OEM”) is to verify the compliance of the new pipes from the pipe mill with the purchase order prior to assembling them into a new Riser. A limited manual 1D-NDI sampling (herein referred to as “Spot-Checks”) is sufficient to verify compliance. The Riser-OEM Spot-Checks comprises of a number of manual spot readings that typically cover less than 1% of the pipe, again, due to the limitations of the available 1D-NDI technology. However, this Riser-OEM Spot-Checks is inadequate and inappropriate for the inspection of used Riser where 100% inspection coverage is essential for the calculation of the maximum (peak) Riser stresses. It should also be noted that Riser-OEM Spot-Checks is inadequate and inappropriate for the inspection of all other new or used Oil-Country-Tubular-Goods, hereinafter after referred to as “OCTG”, like drill pipe.

The Riser-OEM Spot-Checks comprise of one or more of: a) a few ultrasonic (UT) readings around the pipe circumference, typically 4 readings spaced 2 to 5 feet apart, proving less than 0.1% inspection coverage for wall thickness only; b) a limited eddy-current inspection (EC) of the ID surface that also provides less than 0.1% inspection coverage for near-surface imperfections only; c) TOFD of welds that may only detect mid-wall imperfections with two diffracting ends. The mid-wall imperfections must be away from the TOFD two inspection dead-zones (the near-surface dead-zone due to lateral waves and the far-surface dead-zone due to echoes); d) mag-particle inspection (MPI) of the welds that is limited to surface and near-surface imperfections on the OD only, after the buoyancy and the paint or coating are removed; e) visual inspection and f) a few dimensional readings. Again, this Riser-OEM Spot-Checks may be adequate to verify the compliance of new pipe with the purchase order; however, it is inadequate for the inspection of used Risers as it leaves over 99% of the Riser condition unknown, a serious safety hazard.

Due to the limitations of 1D-NDI to provide 100% inspection coverage on Riser pipes, certified and monitored inspection companies that specialize in the inspection of new and used OCTG, such as the inspection of drill pipe, production tubing etc., are not involved with the inspection of Risers. This leaves the Riser-OEMs as the only vendors of used Riser inspection. Lacking any other means and used OCTG inspection expertise, Riser-OEMs utilize the same Spot-Checks to inspect used Risers leaving 99% of the Riser condition unknown after the inspection. The simplicity of the spot checks, the modest investment in tools and the lack of required certification and monitoring has encouraged many to enter the used Riser inspection market.

Furthermore, and in order to perform the spot-checks, Riser-OEMs and others require the used Riser to be shipped to one of their facilities onshore. In summary, this involves: a) loading the Riser to a workboat; b) unloading the Riser from the workboat onto a flatbed truck; c) transporting and unloading the Riser at the inspection facility; d) disassembling, removing paint/coating and cleaning the Riser; e) performing the spot-check 1D-NDI; recoating/repainting and reassembling the Riser with 99% of its condition still unknown and g) shipping the Riser back to the rig. Although the Riser is exposed to a high probability of transportation and handling damage including but not limited to disassembly and reassembly errors and omissions, this entire process does not produce sufficient data to verify the used Riser integrity or for the calculation of the maximum (peak) Riser stresses. A careful study may conclude that this process is more harmful than helpful because, among many more, it also a) produces a significant amount of air and water contaminant from the transportation, sand-blasting and pressure-washing of the Riser pipes and b) gives the false sense of security to the rig crew that otherwise may be more vigilant during the deployment or retrieval of the Riser.

It should be noted that for decades drill pipe and other used OCTG inspection mandates 100% inspection coverage by certified and monitored inspection companies using calibrated equipment. Again, Riser-OEM spot-checks do not meet the new or used drill pipe and other OCTG minimum inspection requirements. In offshore drilling, drill pipe is deployed inside the Riser Main Tube along with the drilling and well fluids. The irony of it all is that if the drill pipe breaks it would result in an inconvenience as the Riser will protect the environment and limit any harmful consequences. If the Riser breaks, drilling and well fluids and gases would be released immediately to the environment with limited means to control the damage and the pollution. It should also be noted that gases may reach the surface underneath or very near the floating platform and may ignite, a familiar Gulf-of-Mexico scenario. In other words, 100% inspection coverage by a certified and monitored company is specified to prevent an inconvenience while 1% or less inspection coverage by anybody is deemed adequate to prevent a disaster.

Riser Analysis

Due to lack of 1D-NDI useful data, Riser analysis is still carried out using ideal Riser material assumptions such as: a) the material is assumed to be Linearly Elastic; b) the material is assumed to be Homogeneous (having the same material properties at all points); c) the material is assumed to be Isotropic (having the same properties at all directions); d) the cross-sectional-area (herein referred to as “CSA”) of the material is Circular throughout its Length; e) the CSA is constant throughout its Length and f) the Riser is straight. These assumptions simplify the Riser analysis while it is further assumed that any unknowns, errors and omissions are covered when the calculated Riser maximum stresses do not exceed, for example, 0.67 of the material specified minimum yield strength. This assumption may be allowable for normal operating conditions. However, under abnormal, contingency, extreme, emergency and survival conditions the knowledge of the actual strength of the weakest riser joint in the string becomes the key to survival, not an assumed value of an ideal material that is never present in a string.

Furthermore, the greater water depths are now overshadowing the ideal Riser material assumptions. This is equivalent to high altitude mountain climbing whereby the lack of oxygen at or above the death-zone overshadows the skills, endurance and determination of the climber. However, as opposed to the mountain climbing fixed death-zone altitude, the Riser death-zone depends on the condition of each Riser joint. For example, quoting from API 16F “3.74 Stress Amplification Factor (SAF): The factor is used to account for the increase in the stresses caused by geometric stress amplifiers that occur in riser components”. Geometric stress amplifiers: a) are never present in ideal material; b) they are not the same from Riser joint to Riser joint; c) can only be determined from NDI data that cover 100% of the volume of the Riser joint and d) is capable of “determining the cause(s) of the damage or deterioration” per API 579-1/ASME FFS-1.

Therefore, there is an offshore drilling industry need for an automated system to calculate maximum Riser stresses during deployment using deployment data along with Riser material and geometry data, including the effects of geometric stress amplifiers, and to compare said stresses to failure-criteria to determine if the Riser string is still fit-for-deployment per API 16Q, API 16F, DNV, ABS and all other specifications and requirements.

### SUMMARY OF THE INVENTION

It is reasonable to conclude from the aforementioned that the purpose of the Riser inspection is to acquire a sufficient number of good quality specific data to facilitate a Riser response Analysis that includes, but is not limited, to a calculation of maximum Riser stresses to verify that they do not exceed the allowable stresses under Loading, preferably using the von Mises stress failure criterion. The Analysis should include, but is not limited to, the effects of corrosion, crack-like-flaws, fatigue, geometric-distortion, groove-like-flaws, hardness, local wall thickness misalignment, pit-like-flaws, wall thickness, wear, and other stress-concentrators (geometric stress amplifiers), herein referred to as “Imperfections”. Imperfections that exceed an alert threshold are herein referred to as “Flaws”. Imperfections that exceed an alarm threshold are herein referred to as “Defects”.

As opposed to Riser codes, standards and 1D-NDI, computers and finite element analysis software, herein referred to as “FEA”, have made great strides widening the gap between Riser Analysis and Riser Inspection.

Furthermore, a condition based maintenance is preferable when the Riser inspection can detect a spectrum of degradation (DNV-F206) and determine the causes of degradation (API 579-1/ASME FFS-1). Therefore, RiserSEA should detect and recognize a spectrum of Imperfections and analyze their combined effects on the Riser under loading. It should then be understood that RiserSEA analysis results in an affirmative verification that the as-is Riser exceeds a minimum strength requirement or should be rerated or should be repaired or should be removed from service.

In one possible embodiment, RiserSEA comprises an Autonomous Constant-Vigilance (herein after referred to as “AutoCV”) system or elements thereof may be provided to ascertain and/or to mitigate hazards arising from the failure of an MUA resulting from misapplication and/or deterioration of the MUA. The AutoCV system may comprise elements such as, for instance, a computer and an MUA Features acquisition system. The MUA Features acquisition system may be used to scan the MUA and identify the nature and/or characteristics of MUA Features. A computer program may evaluate the impact of the MUA Features upon the MUA by operating on the MUA Features, said operation guided by a database constraints selected at least in part from knowledge and/or rules and/or equations and/or MUA historical data. The AutoCV system may acquire Loads and Deployment Parameters by further comprising of a data acquisition system. A computer program may evaluate the impact of the Loads and Deployment Parameters upon the MUA by operating on the MUA Features, said operation guided by a database constraints selected at least in part from knowledge and/or equations and/or rules. A computer program may convert the MUA data to a data format for use by a Finite Element Analysis program (herein after referred to as “FEA”), also known as an FEA engine, or a Computer Aided Design program (herein after referred to as “CAD”),

The computer program may further combine the as-is MUA components into a functional (operational) MUA model, such as a structure, an engine, a pump or a BOP. The computer may further recalculate the physical shape of each as-is MUA component using Features, Loads, Deployment Parameters, constraints, equations, rules and knowledge and may then operate the MUA model to verify that the MUA is still functional as intended within a safe operational-envelop and in an emergency, guide the crew on the limits of exceeding the safe operational-envelop.

The computer program may further combine as-is MUA models to assess the functionality of a complex system, such as the as-is drill pipe inside the as-is Riser and the as-is subsea BOP. Such a simulation will also take into account the as-is drill pipe, Riser and BOP including, but not limited to, as-is shape, wall thickness, hardness, hydraulic pressure and temperature and other pertinent Features, Loads and Deployment Parameters.

These and other embodiments, objectives, features, and advantages of the present invention will become apparent from the drawings, the descriptions given herein, and the appended claims. However, it will be understood that above-listed embodiments and/or objectives and/or advantages of the invention are intended only as an aid in quickly understanding certain possible aspects of the invention, are not intended to limit the invention in any way, and therefore do not form a comprehensive or restrictive list of embodiments, objectives, features, and/or advantages.

### BRIEF DESCRIPTION OF DRAWINGS

FIG. 1 illustrates a block diagram of an example of an AutoCV system, of which RiserSea may be a component, deployed with an offshore drilling rig in accord with one possible embodiment of the present invention;

FIG. 2 illustrates a block diagram of an example a surface AutoCV system deployed at the rig floor of an offshore drilling rig in accord with one possible embodiment of the present invention;

FIG. 3A illustrates an example of a Two-Dimensional (2D) Extraction Matrix in accord with one possible embodiment of the present invention;

FIG. 3B illustrates an example of a Identifier Equations in accord with one possible embodiment of the present invention;

FIG. 3C illustrates an example of a Three-Dimensional (3D) Stress Concentration graph for use in a stress concentration factors calculation in accord with one possible embodiment of the present invention;

FIG. 4 illustrates an example of Critically-Flawed-Path on a tube showing related measurements and related critically flawed areas in accord with one possible embodiment of the present invention.

FIG. 5A is an elevational view of a floating drilling rig with a deployed riser connecting to a subsea BOP;

FIG. 5B is an elevational view of a floating drilling rig of risers such as those as indicated in FIG. 1A that do not include buoyancy jackets;

FIG. 5C is an elevational view of a floating drilling rig of risers such as those as indicated in FIG. 1A that do include buoyancy jackets;

FIG. 6A is an end view of a possible marine drilling riser coupling;

FIG. 6B is a view of risers in a shipyard prior to deployment;

FIG. 7 is a RiserSEA and/or component of AutoCV block diagram in accord with one embodiment of the present invention;

FIG. 8 is an illustration of an addressable sensor array in accord with one embodiment of the present invention;

FIG. 9A is an example of a Riser Fitness Certificate;

FIG. 9B is an example of signals produced in accordance with RiserSEA in accord with one possible embodiment of the present invention;

FIG. 10 is an example of an export to FEA analysis of pipes, risers, umbelicals, and the like in accord with one possible embodiment of the present invention.

### DESCRIPTION OF EMBODIMENTS OF THE PRESENT INVENTION

To understand the terms associated with the present invention, the following descriptions are set out herein below. It should be appreciated that mere changes in terminology cannot render such terms as being outside the scope of the present invention. Details of the terms and systems for providing these functions are also discussed in respective of our previous patents which are referenced herein.

Autonomous: able to perform a function without external control or intervention, which however may be initiated and/or switched off and/or verbally interacted with and/or visually interacted with and/or auditorily interacted with and/or revised and/or modified as desired by external control or intervention.

AutoNDI: Autonomous Non-Destructive Inspection

AutoFFS: Autonomous Fitness-For-Service

AutoFFSE: Autonomous Fitness-For-Service-Estimation

AutoRULE: Autonomous Remaining-Useful-Life-Estimation

AutoCV: Autonomous Constant-Vigilance Assessment method and equipment carried-out, at least in part, by the exemplary STYLWAN Rig Data Integration System (RDIS-10) and incorporating herein by reference in their entirety the following: U.S. patent application Ser. No. 13/304,061, U.S. patent application Ser. No. 13/304,136, U.S. Pat. No. 8,086,425, U.S. Pat. No. 8,050,874, U.S. Pat. No. 7,403,871, U.S. Pat. No. 7,231,320, U.S. Pat. No. 7,155,369, U.S. Pat. No. 7,240,010, and any other patents/applications. In the prior art, FFS and RULE was typically performed by an expert or a group of experts using as-designed data and assumptions while the AutoCV assessment is based primarily on as-built or as-is data. When design data is available, AutoCV also monitors compliance with the design data. When less than optimal data is available, AutoCV may perform a Fitness-For-Service-Screening (Herein after referred to as “FFSS”). RiserSea may be a

Degradation Mechanism: the phenomenon that is harmful to the material. Degradation is typically cumulative and irreversible such as fatigue built-up.

Essential: important, absolutely necessary.

Expert: someone who is skillful and well informed in a particular field.

Feature: a property, attribute or characteristic that sets something apart.

Finite Element Analysis (Herein after referred to as “FEA”): a method to solve the partial or ordinary differential equations that guide physical systems.

FEA Engine: is an FEA computer program, a number of which are commercially available such as Algor and Nastran. In practice, FEA engines are used to analyze structures under different loads and/or conditions, such as a Riser under tension and enduring vortex induced vibration (Herein after referred to as “VIV”). An FEA engine may analyze a structure with a feature under static and/or dynamic loading, but not a feature on its own.

Fitness For Service: typically an engineering Assessment to establish the integrity of in service material, which may or may not contain an imperfection, to ensure the continuous economic use of the material, to optimize maintenance intervals and to provide meaningful remaining useful life predictions.

Imperfection: one of the material features—a discontinuity, irregularity, anomaly, inhomogeneity, or a rupture in the material under Assessment. Imperfections are undesirable and often arise due to fabrication non-compliance with the design, transportation mishaps and MUA degradation. A Flaw is an Imperfection that exceeds an alert-threshold when monitored in accord with an embodiment of the present invention and typically places the MUA in the category of requiring in-service monitoring. A Defect is an Imperfection that exceeds an alarm-threshold for reliable use when monitored in accord with an embodiment of the present invention and may require removal from service, repair, remediation, different use and/or the like.

Knowledge: a collection of facts and rules capturing the knowledge of one or more specialist and/or experts.

Operational Envelop: the context of the conditions under which it is safe to use.

Remaining Useful Life: a measure that combines the material condition and the failure risk the material owner is willing to accept. The time period or the number of cycles material (a structure) is expected to be available for reliable use.

Remaining Useful Life Estimation: establishes in one possible embodiment the next monitoring interval or the need for remediation but it is not intended to establish the exact time of a failure. When Remaining Useful Life can be established with reasonable certainty, the next monitoring interval may also be established with reasonable certainty. When Remaining Useful Life cannot be established with reasonable certainty, then RULE may establish the remediation method and upon completion of the remediation, the next monitoring interval may be established. When end of useful life is established with reasonable certainty, alteration and/or repair and/or replacement may be delayed under continuous monitoring.

Rules: how something should be done or not be done concerning MUA based upon know and/or detected facts.

Assessment of equipment, systems and processes

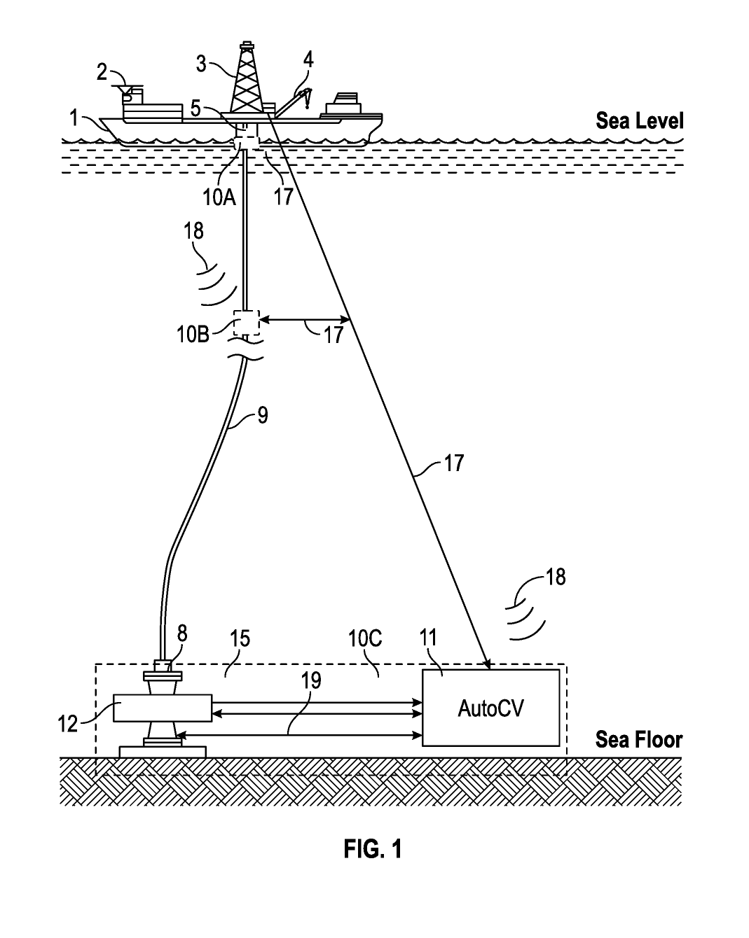

Referring now to the drawings, FIG. 1 illustrates an offshore drilling rig 1. The offshore drilling rig 1 was selected as an example for a Constant-Vigilance application because it encompasses a large variety of materials, some safety-critical, deployed under extreme conditions. In this example, Constant-Vigilance monitors the drilling process through a number of distributed AutoCV systems in continuous communication with each other and each specifically configured for its assignment. However, the present invention is not limited to this particular application and may also be implemented in previously discussed and/or alluded to applications and/or other applications.

It should be understood that complex equipment, systems and processes, safety-critical or otherwise, are coupled closely and their interaction(s) is very complex. Even small changes may form a chain that may propagate through the system, amplify and may trigger a failure that cannot be predicted readily by a cursory look. Furthermore, equipment, systems and processes, especially safety-critical, preferably must exhibit high-reliability and fault-tolerance, whereby some operational capacity is still available after a failure.

Assessment of equipment, systems and processes, especially safety-critical, according to the present invention, preferably starts from the top and defines and prioritizes the key requirements of the operational-envelop and the risks associated with the failure-paths. It is a unique feature of one possible embodiment of the present invention that whoever performs the Assessment must examine and include in the MUA historical data a list of Loads, Deployment Parameters, Environment, Risk and Failure-chains to specifically exclude from list parts that do not belong in the Operational-Envelop of the MUA deployment. Then, the characteristics and values of the remaining Loads, Deployment Parameters, Environment, Risk and Failure-chains should be defined like chemistry, cyclic, magnitude, maximum, minimum, peak, phase, probability, pulsating, range, span, steady, units of measurement, combinations of the above and similar items. This list guides/reminds/helps whoever performs the Assessment or a follow-up Assessment to judge and confirm and to seek knowledge, search, ask for help or obtain an expert opinion(s) from the start of the Assessment process.

For example, such a list would have guided/reminded the HMAN Westralia crew that the fuel hoses do not only endure static pressure, but they also endure vibration (attached to a diesel engine), pulsating pressure (attached to a pump) and the other Loads, Deployment Parameters and Environment a sea going vessel encounters. A cursory search of the engine manuals and the manufacturer's bulletins could have averted this disaster as the pulsating pressure peak value was extensively discussed and is considered general knowledge among marine engineers and others.

Assessment then progresses downwards and splits the system into sub-systems and eventually components. For each sub-system and component, Assessment defines and prioritizes the key requirements of its operational-envelop and the risks associated with its failure-paths as aforementioned. It should be understood that the failure-paths of sub-systems and components may define additional requirements and/or may reformulate the risk associated with the overall system whereby restarting the Assessment from the top again (Assessment feedback). Assessment therefore knows by some detail the risks associated with each sub-system and component and then specifies the good quality inspection(s), scope and techniques including the number and type of specific data to facilitate the Assessment and to preferably disrupt the accident-chain(s).

The most effective way to manage complex equipment, systems and processes is to translate them, when possible, to a mathematical description that simplifies the detection and assesses subtle changes that people and organizations would miss with a cursory look thus warns about errors and contains failures by actively disrupting the failure-chains with knowledge. Occasionally, humans tend to misinterpret, misunderstand, simplify and dismiss subtle readings and changes, such as the pressure readings on the Deepwater Horizon. On the other hand, AutoCV mathematical description allows for higher-resolution Assessment, allows for overall system Assessment and it will not simplify or dismiss subtle changes.

Autonomous Constant-Vigilance System

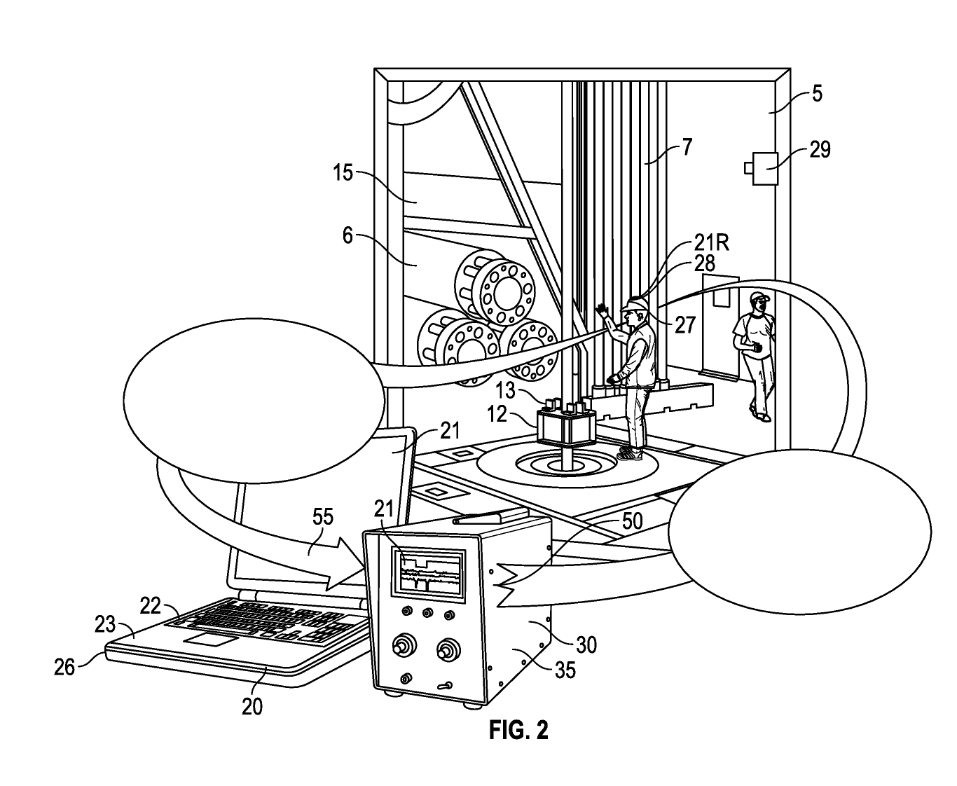

The exploration, production, transportation and processing of hydrocarbons, onshore or offshore, utilizes substantially similar equipment and configuration of equipment. For example, a metallic or composite cylinder (with or without end connectors and/or welds) may be referred to as casing, coiled tubing, drill pipe 7, Riser 6, (see FIG. 2) pipe, pipeline, tubing etc., collectively referred to herein as OCTG and designated as MUA 9 (shown Riser 6 main tube and auxiliary lines with the drill pipe 7 inside the main tube). Similarly, a valve or a configuration of valves is referred to as control valve, diverter valve, relief valve, safety valve, BOP 8 etc. A structure is referred to as an aircraft wing, bridge, derrick 3, crane 4, frame, tower, helicopter landing pad 2 etc. and of course, the rig 1 itself is a sea going vessel comprising of most MUA varieties. Regardless of the MUA name, which may comprise any of the above mentioned elements, AutoCV: a) scans the MUA to detect a plurality of Features; b) recognizes the MUA detected Features and therefore “knows by some detail” the MUA Features; c) associates and connects the recognized MUA Features with known definitions, formulas, risks and MUA historical data, preferably stored in a database; d) creates an MUA mathematical and/or geometrical and/or numerical description compiled through the mathematical, geometrical and numerical description of the MUA recognized Features (herein after referred to as “Mathematical Description”); e) converts the MUA recognized Features into a data format for use by an FEA and/or a CAD program; f) calculates Feature change-chain and compares with stored failure-chains for a match; g) calculates a remediation to disrupt the Feature change-chain (disrupt the failure-chain early on) and h) updates the MUA historical data database.

The MUA Mathematical Description is then acted upon by the Loads and Deployment Parameters, sufficient for calculating an MUA FFS and RULE to predict an MUA behavior under deployment in accord with an embodiment of AutoCV operation. Furthermore, the MUA Mathematical Description may be converted to an MUA functional model or prototype which may be operated to verify MUA functionality directly and/or through a CAD program and/or through an FEA program.

FIG. 1 illustrates some components of the drilling process that are critical. The Riser joints 6 connect the rig 1 to the subsea BOP 8. Risers 6 comprise at least a main tube, typically 21 inches OD, and a number of auxiliary lines. The drill pipe 7 reaches the strata through the Risers 6 main tube and through the BOP 8. Riser 6 main tube also acts as the primary conduit of the drilling fluids to the rig 1. The BOP 8 main function is to shear the drill pipe 7 and to seal the well in the event of an accident.

The Riser string, which could conceivably be less than or greater than 10,000′ long, is not only exposed to the hydrostatic pressure, it is also exposed to the ocean currents that change direction with depth. Therefore, the riser string is a flexible structure that also experiences varying side loads, some of which lead to vortex induced vibration (VIV). Anyone can place vibration monitors along the Riser string, collect VIV data, write a paper and contribute to the general knowledge. However, as was discussed above, general knowledge does not prevent an accident.

AutoCV on the other hand, recognizes that it is not a generic riser joint that endures VIV but a very specific riser joint that endures a very specific VIV loading (frequency, magnitude etc.) that changes minute by minute. VIV adds to the cyclic fatigue and acts upon the Features of the specific riser joint. Therefore, knowing in detail the fatigue status and the other features (wall-thickness, corrosion, hardness etc.) of each riser joint in the riser string (the subtle readings and changes), AutoCV assesses accurately the risk factors associated with the specific riser joint under the specific deployment loads and thus, it disrupts a failure-chain with exact knowledge that is continually updated. On the other hand, Riser inspection that acquires very few readings only adds an insignificant amount of information beyond what is known about a generic riser joint.

AutoCV also recognizes that it is not a generic drill pipe joint across the generic shear rams of a generic BOP. Instead, AutoCV recognizes that, at any given moment, there is a very specific length of a very specific drill pipe joint (specific wall-thickness, corrosion, hardness, tool joint etc.) across the very specific shear rams of a very specific BOP and thus, it disrupts another failure-chain with exact knowledge that is continually updated.

Constant-Vigilance uses this specific knowledge to select inspection and monitoring instruments, such as the exemplary AutoCV system, and then strategically locate them around the rig. It should be understood that this selection is based on safety and business values and therefore, not all equipment that are discussed in the examples below would be deployed in all similar applications.

Subsea AutoCV

The subsea AutoCV 10C comprises of at least one console 11, an Assessment head 12, a number of sensors 15, a power and communication link 17 and/or a wireless and/or sonic and/or underwater modem and/or other types of communicators and/or chain or relay stations that provide communication link 18 and a power and control link 19. The console 11 comprises of at least one computer with software connected to a Features detection interface and a data acquisition system. The data acquisition system is connected to sensors 15 comprising of numerous Loads and/or Deployment Parameters sensors that may include one or more subsea cameras. Console 11 further comprises of a power backup with sufficient storage to safely operate AutoCV 10C and maintain communication with the rig floor AutoCV 10A through the communication links 17, 18 and control link 19.

Assessment head 12 comprise of at least one Features detection sensor which in one embodiment may produce data which when utilized in the software or equations of the present invention can distinguish and/or measure one, two, or three physical dimensions of and/or classify one, two, or three physical dimensions, and/or one, two or three physical dimensions of different Features and/or measure changes in Feature-morphology, fatigue, or the like (See for example U.S. Pat. No. 7,155,369 Autonomous Non-Destructive Inspection, incorporated herein by reference in its entirety). The features detection system is preferably not limited to “one-dimensional” information in the sense that “one-dimensional” data simply provides, for example, an electrical signal that may change due to numerous reasons and therefore it is often unable to distinguish much less measure or describe significant and non-significant one dimensional physical variations of one, two or three dimensions of different features, and cannot realistically distinguish, much less measure or classify one, two or three physical dimensional aspects of different features. However, AutoCV may utilize multiple “one-dimensional” sensors that when combined may be utilized with equations to detect, measure and/or distinguish one, two or three dimensional different features. (See, for example, U.S. Pat. No. 7,231,320 Extraction of Imperfection Features through Spectral Analysis, referenced hereinbefore and incorporated herein by reference).

The subsea AutoCV 10C communicates with and monitors the BOP 8 controls through the control link 19. For example, in one possible embodiment, control link 19 may du-plicate the function of the power and communication link 17 whereby AutoCV 10C is powered by and communicates with the rig floor AutoCV 10A through the BOP 8 controls. In addition to performing a continuous FFS, RULE and operating a model of the BOP 8, the subsea AutoCV 10C may prevent BOP 8 actions that may damage the BOP 8 or at least notify and ask for confirmation from the surface before the BOP 8 action is permitted. It should be understood that, as an Assessment of the system and the drilling process, the rig floor AutoCV 10A and the subsea AutoCV 10C are in continuous communication and act as one whereby, for example, the rig floor AutoCV 10A may prohibit pipe movement when the BOP 8 pipe rams are closed until such time that the action is confirmed. It is envisioned that such notification will be carried out through the rig floor AutoCV 10A visual, speech and sound interface (see FIG. 2 items 21, 31R, 50 and 55) whereby, in case of an emergency, the rig floor AutoCV 10A would automatically connect to additional speakers around the rig and increase the volume to an appropriate level to announce the emergency.

It should further be understood that the subsea AutoCV 10C would then monitor and confirm that the BOP 8 action was performed as intended and report back or calculate and/or estimate the degree by which the action was performed using data obtained through the Assessment head 12 and/or Loads and Deployment Parameters sensors 15, such as battery status, position of BOP 8 rams, activation of valves and controls, control's pressure, differential pressure across the rams and similar items. Monitoring the sound and the flow inside the BOP 8 or the Risers 6 would be a measure of success in closing the rams to seal the well.

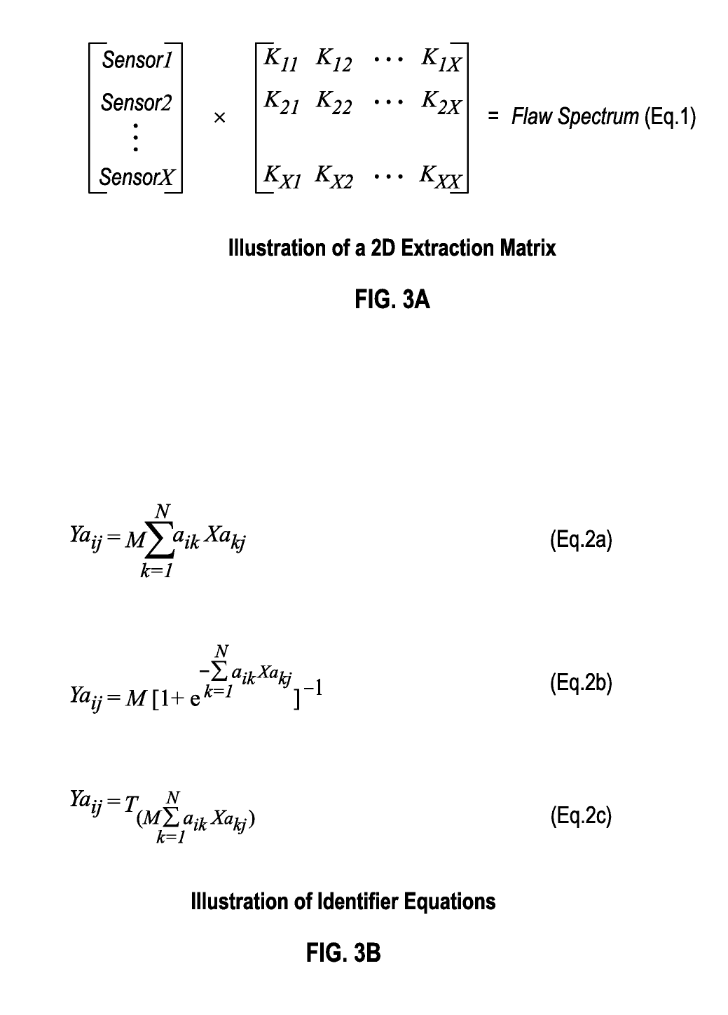

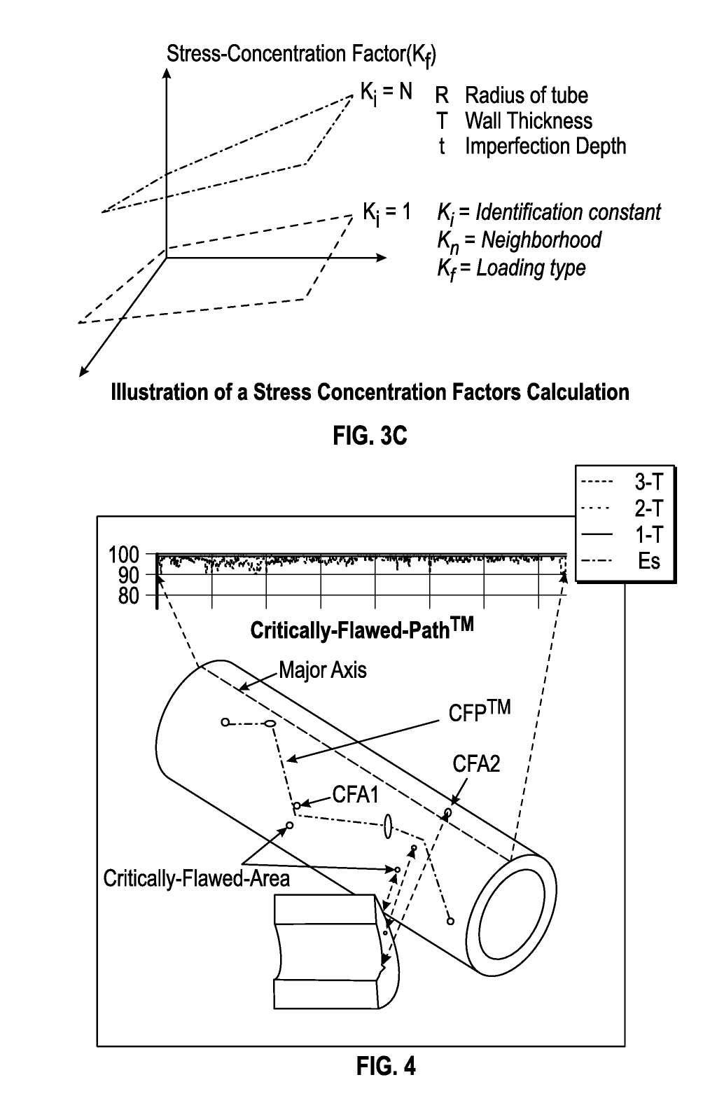

Referring to Deepwater Horizon, the BOP monitor of U.S. Pat. No. 7,155,369, FIG. 3, incorporated herein by reference in its entirety, would have detected the conditions around the BOP 8 shear rams and would have alerted the driller instantly if the sheared drill pipe fell into the well away from the rams; while there was still thousands of feet of fluid inside the Riser. It would also have alerted the driller that the drill pipe did not fall away, in other words it did not shear completely, or if the drill pipe is bend or additional material is jamming the rams. This knowledge alone would have saved countless days of futile attempts to close the Deepwater Horizon BOP shear rams. Almost a year later and at enormous cost, the DNV report reflects what could have been known onsite instantly, knowledge that may have given the rig crew a fighting chance; a prime example of the high cost of lack-of-knowledge.

### AutoCV Standalone Operation

The subsea AutoCV 10C is also capable of standalone operation in the event of a mishap. The subsea AutoCV 10C may be notified of a mishap or recognize a mishap through the Assessment head 12 and/or Loads and Deployment Parameters sensors 15 and/or sound recognition 55 and/or through data loss or even loss of external power. The subsea AutoCV 10 would then enter the automatic standalone operation mode after a certain amount of time without communication with the rig floor AutoCV 10A and/or after a number of failed communication attempts or by receiving a command to enter the standalone operation mode.

The actions of the subsea AutoCV 10C may be controlled by the material inside the BOP 8 and/or information derived from Loads and Deployment Parameters sensors 15 and/or sound recognition 55 (See FIG. 2) and may be limited by the amount of stored backup power. The subsea AutoCV 10C may be programmed with an active and/or a passive standalone mode. In the active standalone mode, the subsea AutoCV 10C may analyze the information from the sensors using onboard stored expert knowledge and may attempt to power and/or operate at least part of the BOP 8 if the expert analysis suggests, for example, a well blowout. In the passive standalone mode, the subsea AutoCV 10C may monitor and relay to the surface data obtained through the Assessment head 12 and/or Loads and Deployment Parameters sensors 15, such operation optimized to extend the power backup life. It is envisioned that the subsea AutoCV 10C may integrate a complete BOP 8 control system.

Mid-Level AutoCV

A number of AutoCV 10B may be deployed along the length of the Riser string to perform functions substantially similar to the subsea AutoCV 10C. For example, AutoCV 10B may be located at a certain depth where known currents initiate VIV. AutoCV 10B system(s) may be in communication by various means as discussed hereinbefore with AutoCV 10A and 10C systems. In addition, as part of a fault-tolerant system, the AutoCV 10B may be equipped with a flow restrictor to be deployed in case of a mishap. The flow restrictor may be as simple as an inflatable bladder with a fluid or compressed air reservoir or a ram and support equipment.

Rig Floor (Surface) AutoCV

FIG. 2 illustrates one possible embodiment of AutoCV 10A deployed on the rig floor 5 where it may be used to: a) assess the status of the OCTG; b) assess the status of other rig equipment, such as mooring, lifting and tensioner cables, tensioner cylinders and pistons, BOP 8, etc., c) assess the status of the rig structure and d) assess the status of complete systems and processes. It should be understood that AutoCV 10A may utilize different types and/or shapes and/or configurations of assessment heads 12 to fulfil the Assessment needs of the different MUAs which are referenced hereinbefore or after.

In this embodiment, AutoCV 10A comprise of at least one computer 20, with a display 21 and a remote display 21R, storage 23, an Assessment head 12 (shown while scanning drill pipe 7 as it is tripped from the well), a position and speed encoder 13, a features detection interface 30 and a data acquisition system 35 connected to numerous Load and Deployment Parameter sensors 15 distributed around the rig. The rig floor AutoCV 10 communicates with other AutoCV system, which may selectively be deployed around the rig, through wired and wireless communication links 26 that also allows for access to remote experts, computers and stored knowledge. The AutoCV 10A communicates with an operator or the rig crew through displays 21 and 21R, keyboard 22, Natural Speech and Sound interface 50 connected to a speaker or earphone 27 (helmet mount is shown) and a Speech and Sound recognition interface 55 connected to a microphone 28. It should be understood that not all AutoCV components would be deployed in all applications.

Material Identification

Material identification is critical for the Assessment process. The present invention provides means of correcting some misidentifications but not necessarily all. In addition to identification through camera 29 and/or operator identifying the material through keyboard 22, microphone 28, speech 55 and/or other inputs or stored information, at least one communication link 26 may facilitate communication with an identification system or a tag, such as RFID, affixed to MUA. Such identification tags are described in U.S. Pat. No. 4,698,631, No. 5,202,680 and No. 6,480,811 and are commercially available from multiple sources such as Texas Instruments, Motorola and others: Embedded tags specifically designed for harsh environments, are available with user read-write memory onboard (writable tag). It is anticipated that the memory onboard identification tags would increase as well as the operational conditions, such as temperature, while the dimensions and cost of such tags would decrease.

Computer 20 preferably provides for data exchange with the material identification system, including but not limited to, material ID, material geometry, material database, preferred FEA model, preferred evaluation system setup, constraints, constants, tables, charts, formulas, historical data or any combination thereof. It should be understood that identification systems may further comprise of a data acquisition system and storage to monitor and record Load and Deployment Parameters of MUA 9 (See FIG. 1). It should be further understood that the material identification system would preferably operate in a stand-alone mode or in conjunction with AutoCV. For example, while tripping out of a well, computer 20 may read such data from the drill pipe 7 or tubing identification tag and while tripping into a well, computer 20 may update the identification tag memory. Another example would be an identification computer with a data acquisition system affixed onto a Riser joint 6 or a crane 4. During deployment, such an identification system would preferably monitor and record Load and Deployment Parameters.

Speech and Voice Control

Speech is a tool which allows communication while keeping one's hands free and one's attention focused on an elaborate task, thus, adding a natural speech interface to the AutoCV would preferably enable the operator to focus on the MUA and other related activities while maintaining full control of the AutoCV. Furthermore, the AutoCV natural speech interaction preferably allows the operator to operate the AutoCV while wearing gloves or with dirty hands as he/she will not need to physically manipulate the system.

Language Selection

Different AutoCV may be programmed in different languages and/or with different commands but substantially performing the same overall function. The language capability of the AutoCV may be configured to meet a wide variety of needs. Some examples of language capability, not to be viewed as limiting, may comprise recognizing speech in one language and responding in a different language; recognizing a change of language and responding in the changed language; providing manual language selection, which may include different input and response languages; providing automatic language selection based on pre-programmed instructions; simultaneously recognizing more than one language or simultaneously responding in more than one language; or any other desired combination therein. In the event of an emergency, AutoCV preferably will announce the emergency and the corrective action in multiple languages preferably to match the native languages of all the crew members. It should be understood that the multi-language capability of the AutoCV voice interaction is feasible because it is limited to a few dozen utterances as compared to commercial voice recognition systems with vocabularies in excess of 300,000 words per language.

AutoCV Speech

Text to speech is highly advanced and may be implemented without great difficulty. Preferably, when utilizing text to speech, the AutoCV can readily recite its status utilizing, but not limited to, such phrases as: “magnetizer on”; “chart out of paper”, and “low battery”. It can recite the progress of the AutoCV utilizing, but not limited to, such phrases as: “MUA stopped” and “four thousand feet down, six thousand to go”. It can recite readings utilizing, but not limited to, such phrases as “wall loss”, “ninety six”, “loss of echo”, “unfit material”, “ouch”, or other possible code words to indicate a rejectable defect. The operator would not even have to look at a watch as simple voice commands like “time” and “date” would preferably recite the AutoCV clock and/or calendar utilizing, but not limited to, such phrases as “ten thirty two am”, or “Monday April eleven”.

However, it should be understood that the primary purpose of the AutoCV is to relay MUA (as-designed, as-is etc.) Load and Deployment information to the operator. Therefore, AutoCV would first have to decide what information to relay to the operator and the related utterance structure. It should be understood that in this example AutoCV 10A may further be utilized to coordinate communications for other AutoCV systems.

Assessment Trace to Sound Conversion

The prior art does not present any solution for the conversion of the Assessment to speech or sound. The present invention utilizes psychoacoustic principles and modeling to achieve this conversion and to drive a speech and sound synthesizer 50 with the resulting sound being broadcast through a speaker or an earphone 27. Thus, the assessment signals may be listened to alone or in conjunction with the AutoCV comments and are of sufficient amount and quality as to enable the operator to monitor and carry out the entire assessment process from a remote location, away from the AutoCV console and the typical readout instruments. Furthermore, the audible feedback is selected to maximize the amount of information without overload or fatigue. This assessment-to-sound conversion also addresses the dilemma of silence, which may occur when the AutoCV has nothing to report. Typically, in such a case, the operator is not sure if the AutoCV is silent due to the lack of features or if it is silent because it stopped operating. Furthermore, certain MUI 9 features such as, but not limited to, collars or welds can be observed visually and the synchronized audio response of the AutoCV adds a degree of security to anyone listening. A wearable graphics display 21R could further enhance the process away from the AutoCV console.

AutoCV Sound Recognition

AutoCV would preferably be deployed in the MUA use site and would be exposed to the site familiar and unfamiliar sounds. For example, a familiar sound may originate from the rig engine revving-up to trip an OCTG string out of a well. An indication of the MUA speed of travel may be derived from the rig engine sound. An unfamiliar sound, for example, would originate from a bearing about to fail. It should be noted that not all site sounds fall within the human hearing range but may certainly fall within the AutoCV analysis range when the AutoCV is equipped with appropriate sensors and microphone(s) 28. It should also be noted that an equipment unexpected failure may affect adversely the MUA RUL, thus training the AutoCV to the site familiar, and when possible unfamiliar sounds, such as a well blowout or a high pressure hose leak, would be advantageous.

AutoCV Speech Recognition

Speech recognition is also highly advanced and may be implemented without great difficulty or may be purchased commercially. A typical speech and sound recognition engine 55 may comprise an analog-to-digital (herein after referred to as “A/D”) converter, a spectral analyzer, and the voice and sound templates table. The description of the sequence of software steps (math, processing, etc.) is well known in the art, such as can be found in Texas Instruments applications, and will not be described in detail herein.

Operator Identification and Security

Preferably, at least some degree of security and an assurance of safe operation, for the AutoCV, is achieved by verifying the voiceprint of the operator and/or through facial or iris scan or fingerprint identification through camera 29 or any other biometric device. It should be understood that camera 29 may comprise multiple cameras distributed throughout. With voiceprint identification, the likelihood of a false command being carried out is minimized or substantially eliminated. It should be appreciated that similar to a fingerprint, an iris scan, or any other biometric, which can also be used for equipment security, a voiceprint identifies the unique characteristics of the operator's voice. Thus, the voiceprint coupled with passwords will preferably create a substantially secure and false command immune operating environment.

Voiceprint speaker verification is preferably carried out using a small template, of a few critical commands, and would preferably be a separate section of the templates table. Different speakers may implement different commands, all performing the same overall function. For example “start now” and “let's go” may be commands that carry out the same function, but are assigned to different speakers in order to enhance the speaker recognition success and improve security. As discussed herein above, code words can be used as commands. The commands would preferably be chosen to be multi-syllabic to reduce the likelihood of false triggers. Commands with 3 to 5 syllables are preferred but are not required.

It should be further understood that the authorize operator may also be identified by plugging-in AutoCV a memory storage device with identification information or even by a sequence of sounds and or melodies stored in a small playback device, such as a recorder or any combination of the above.

AutoCV Operation Through Speech

Preferably, the structure and length of AutoCV utterance would be such as to conform with the latest findings of speech research and in particular in the area of speech, meaning and retention. It is anticipated that during the AutoCV deployment, the operator would be distracted by other tasks and may not access and process the short term auditory memory in time to extract a meaning. Humans tend to better retain information at the beginning of an utterance (primacy) and at the end of the utterance (recency) and therefore the AutoCV speech will be structured as such. Often, the operator may need to focus and listen to another crew member, an alarm, a broadcasted message or even an unfamiliar sound and therefore the operator may mute any AutoCV speech output immediately with a button or with the command “mute” and enable the speech output with the command “speak”.

The “repeat” command may be invoked at any time to repeat an AutoCV utterance, even when speech is in progress. Occasionally, the “repeat” command may be invoked because the operator failed to understand a message and therefore, “repeat” actually means “clarify” or “explain”. Merely repeating the exact same message again would probably not result in better understanding, occasionally due to the brick-wall effect. Preferably, AutoCV, after the first repeat, would change slightly the structure of the last utterance although the new utterance may not contain any new information, a strategy to work around communication obstacles. Furthermore, subsequent “repeat” commands may invoke the help menu to explain the meaning of the particular utterance in greater detail.

It should be appreciated that the present invention incorporates a small scale speech recognition system specifically designed to verify the identity of the authorized operator, to recognize commands under adverse conditions, to aid the operator in this interaction, to act according to the commands in a substantially safe fashion, and to keep the operator informed of the actions, the progress, and the status of the AutoCV process, especially in the event an emergency.

AutoCV Assessment

New material may or may not be fabricated as-designed and the design is often based on certain assumptions which may or may not be correct, such as the gusset plates of the I-35W bridge in Minneapolis. Furthermore, the in-service (used) material deterioration is cumulative over time. AutoCV 10 (which may comprise AutoCV 10A, AutoCV 10B, AutoCV 10C and/or other AutoCV systems) provides a quantitative Assessment of a new or an in-service material to ascertain its suitability for a service. AutoCV Assessment is based on the as-is material Mathematical Description coupled with the historical data, the measured Loads and Deployment Parameters.

The MUA historical data should relay sufficient knowledge about the MUA, the deployment conditions and the boundaries (Accept/In-service monitoring/Reject-Redeploy) to adequately define the automatic Assessment Fitness categories and/or the safe-operating zone(s) and to create and operate an MUA FEA model. Typically, historical data define or permit for the calculation of the MUA safe-operating zone(s). Initial historical data is typically provided by the MUA owner/user/manufacturer and consists of:

a) Design data such as drawings, material specifications, design parameters and assumptions, loads, limits, constraints and calculations to adequately define the as-designed MUA;

b) Fabrication data such as drawings, material specifications, weld and heat-treatment reports, measurements and manufacturing inspection records to adequately define the as-built MUA;

c) Maintenance data such as alterations, adaptations, repairs and inspection records to adequately define the as-last-known MUA and

d) Loads, Deployment Parameters, Environment, Risks and Failure-chains as discussed above. The location (longitude and latitude) may be sufficient to define some of the loads and boundaries like the formation, prevailing ocean currents, seismic activity and similar items.

The function of the features detection interface 30 is to induce controlled excitation into the MUA through the Assessment head 12 and to detect the response of the MUA through the sensors of the Assessment head 12. It should be appreciated that the Assessment head 12, whole or in part, may be applied to the outside or to the inside of the MUA or any combination thereof to cover the Assessment needs of MUA. It should also be understood that not all Assessment head 12 functions and components would be deployed simultaneously or in all applications. It should further be understood that the assessment heads 12 may operate in an active mode (induce full excitation) or in a bias mode (induce modified excitation) or in a passive mode (monitor the sensors only).

The Assessment head 12 sensor signals are preferably band limited and are converted to, lengthwise or timewise, time-varying discrete digital signals which are further processed by at least one computer 20 utilizing an extraction matrix (illustrated in FIG. 3A) to decompose the time-varying discrete digital signals into the flaw spectrum (flaw spectrum is a trademark of STYLWAN). The extraction matrix concept was published in 1994 and it is beyond the scope of this patent but it applies equally to any MUA some of which are referenced hereinbefore or after.

Mathematical Description of the MUA

The flaw spectrum is then processed by a system of identifier equations, as illustrated in FIG. 3B, resulting in a Mathematical Description of the MUA compiled through the Mathematical Description of its Features. At least one computer 20 utilizes stored constraints and/or knowledge and/or rules and/or equations and/or MUA historical data to identify the nature and/or characteristics of MUA Features so that at least one computer 20 knows by some detail the MUA Features and connects and associates the MUA Features with known definitions, formulas, Mathematical Description, FEA, CAD and similar items resulting in Identification Coefficient(s) Ki. It should be understood that Ki may be a number and/or an equation, an array of numbers and/or equations, a matrix, a table or a combination thereof

Under certain geometrical conditions, Features in proximity may form a Critically-Flawed-Area (CFA) (Critically-Flawed-Area and CFA are trademarks of STYLWAN), even Features that are mundane on their own. A root-cause of a failure would be a 1D-NDI inspector dismissing mundane Features without taking into account their interaction in the overall system. STYLWAN defines a CFA (illustrated in FIG. 4) as “an MUA area that fosters crack initiation due to high stress concentration and promotes rapid crack propagation through bridging”. Therefore, the Feature's Neighborhood is another critical Assessment parameter that 1D-NDI over-looks. At least one computer 20 examines the lengthwise flaw spectrum for other Neighborhood Features resulting in Neighborhood Coefficient(s) Kn. It should be understood that Kn may be a number and/or an equation, an array of numbers and/or equations, a matrix, a table or a combination thereof.

At least one computer 20 may further measure and acquire MUA Loads and/or Deployment Parameters by operating a data acquisition system 35 connected to numerous Load and Deployment Parameter sensors 15 resulting in Loading Coefficient(s) Kf. It should be understood that Kf may be a number and/or an equation, an array of numbers and/or equations, a matrix, a table or a combination thereof. At least one computer 20 further calculates and verifies that the MUA is operating within the safe-operating zone(s) of the operational-envelop. When the MUA is operated outside the safe-operating zone(s), at least one computer 20 alerts the operator and logs the conditions, time and event duration. AutoCV may further be programmed to permit such operation for a limited duration, to permit the operation under instructions from the operator or to inhibit the operation of MUA. FIG. 1 numerous AutoCVs may also be programmed to determine the root-cause(s) of the operating anomaly, for example, a well blowout may be determined by the upward traveling wellbore flow and associated pressure and sound.

A computer program may further evaluate the impact of the MUA Features, and Deployment Parameters upon the MUA by selecting and applying Load specific Stress-Concentration and/or Deterioration Coefficients from equations, look-up tables or 3D charts as illustrated in FIG. 3C. Load specific Stress Concentration factor values may be obtained from the literature, from equations, from FEA or a combination thereof. Some Deterioration Coefficients may also be obtained from the literature, however, more accurate location specific Deterioration Coefficients may be obtained from previously acquired flaw spectrums in proximity to the deployment location. Therefore, coupling lengthwise flaw spectrums with longitude and latitude also results in a 3D history of the location/formation.

Numerical Description of the MUA

The simplest form of a MUA Mathematical Description is a string of numbers. Strings of lengthwise numbers may represent wall thickness, hardness, corrosion, cracks, fatigue, FFS, RULE, number of cycles, other MUA information or combinations thereof. For example, the string {0.888, 0.879, . . . , 0.876, 0.880} may represent the lengthwise Wall Thickness of a Riser joint in inches. The string {101, 100, . . . 99, 100} may represent the lengthwise Wall Thickness of a Riser joint as percentage of nominal Wall Thickness. The string {155, 161, . . . 157, 160} may represent the lengthwise Brinell hardness of a Riser joint. The string {19.24, 19.28, . . . 19.20, 19.21} may represent the lengthwise internal diameter (ID) of a Riser joint. The string {55.01, 54.87, . . . 54.62, 54.98} may represent the lengthwise cross-sectional area of a Riser joint in square inches, combinations thereof and similar items.

It should be understood that multiple such strings would cover, as close as possible to 100%, the MUA resulting in a string array of a specific type which may comprise multiple pipes that create a multi-conductor riser or a multi-conductor umbilical. A unique feature of the present invention is that calculations using string arrays may reveal additional MUA details and subtle changes that humans and 1D-NDI ignore. For example, the lengthwise minimum and maximum diameter of a tube would permit a full length calculation of ovality a pipe or each conductor of a multi-conductor riser or umbilical used for subsea operations. The internal (ID) and external (OD) diameter string arrays of tubes are also used in the calculation of axial stress, burst yield, collapse yield, fluid volume, hoop stress, overpull, radial stress, stretch, ultimate load capacity, ultimate torque, yield load capacity, yield torque, similar items and combination thereof using formulas and charts found in the literature. In another example, Assessment would examine the temperature readings encountered during a sea-going vessel passage to determine if the ductile-brittle transition temperature was ever reached or preferably Assessment would assign a passage to avoid low temperature areas.

It should further be understood that coupling string arrays with other measured values would result in a detailed geometrical description of the as-is MUA, such as combining the lengthwise internal diameter (ID) string arrays of a tube with the corresponding wall thickness arrays. The geometrical description of the MUA may further be compared with the historical Data such as Design, Fabrication and Alteration records and may be exported as a drawing file for use by CAD programs, simulation programs and FEA engines. MUA non-compliance may be reported to the operator.

Furthermore, comparison of historical data similar strings and Failure-chains may reveal a Feature change, a Feature morphology migration, a Feature propagation and the calculation and identification of a subtle change-chain that matches an early stage of at least one of stored Failure-chains that may be disrupted through remediation before it progresses to a Failure-chain and eventually to an Accident-chain. For example, in Coiled Tubing a crack may initiate at the bottom of a corrosion pit that acts as a stress concentrator under loading (a CFA). The frequent scans of AutoCV would detect the coexisting crack and thus AutoCV will detect the subtle Feature morphology migration from pit to crack, recommend a remediation and disrupt the accident-chain. It should be understood that the transition from Feature change to a Failure (Imperfection to Flaw to Defect) is subtle and lengthy while the transition from Failure to Accident is rapid and sudden. For exarriple, the morphology change-chain may take 98% of the material RUL while the progress to Accident only 2%. This is also the reason sporadic inspections of critical materials are often inadequate.

Critically-Flawed-Path

Computer 20 may further calculate a simpler flaw spectrum by combining all Features of a section, such as a circumference, into an equivalent flaw spectrum using Ki, Kn, Kf coefficients, stored formulas, charts, tables and historical data.

FIG. 4 illustrates the MUA resulting simpler flaw spectrum, a Critically-Flawed-Path (Herein after referred to as “CFP”) (Critically-Flawed-Path and CFP are trademarks of STYLWAN). It should be understood that there is no physical correspondence between the CFP and the MUA Features as CFP is a mathematical construct that only preserves the MUA performance. A conservative Assessment of MUA will place the CFP on the Major/Minor axis of MUA where Features endufe the maximum effects of loading. Under bending, for example, the major axis experiences the maximum tension and the minor axis the maximum compression. It is not uncommon for the major and minor axis to alternate during deployment. Again, it should be understood that the CFP Assessment is very conservative representing the worst case scenario. However, such Assessment is appropriate for safety-critical equipment that must exhibit high operation reliability, such as the BOP 8.

Optimizing System Operation

Typically MUA is part of a system which can be viewed as a complex MUA as discussed earlier. Again, it should be understood that following the analysis, the Assessment of complex MUA closes the loop by starting from the simplest MUA components progressing upwards in complexity. For example, a tool joint is a component of a drill pipe 7, which in turn is a component of the drilling process along with casing, derrick, BOP 8, Risers 6 etc. It is a unique feature of the present invention that the Mathematical Description of the MUA may be further manipulated to address system specific requirements and to optimize the system operation.

For example, the Mathematical Description of each drill pipe 7 joint coupled with their specific location would result in the Mathematical Description of the as-is drill string, a unique feature of the present invention. While drilling, the drill string endures high tensile loads at the surface and high compressive loads at the bottom and therefore, AutoCV knows by some detail the type of loading and the duration each drill pipe 7 joint endured, assess the drill pipe 7 Features under the measured loading and estimates an FFS and RULE. While tripping out of the well, AutoCV 10A would then scan the drill pipe 7 and compare the actual Features, FFS and RULE to the predicted Features by the Assessment while drilling and fine tune the Assessment through these continuous measurements. The Mathematical Description of the as-is drill string may be further manipulated to a CFP to address specific drilling process and equipment needs, such as the specific needs of the BOP 8 rams or other well features or equipment.

For example, in order to address the specific needs of the BOP 8 rams, at least one computer 20 may reprocess the drill string to a special string array of numbers such as {10, 8,8, . . . 1, 1, 3, 1, 1, . . . 1, 4, 8, 8; 10, 10, 8, 8 . . . 1, 1, 1, . . . 8, 8, 10} where 10 may be assigned to a tool joint or a drilling collar (red—do not close BOP 8 rams), 8 may be assigned to safety selected lengths on either side of a tool joint (orange—safety length), 4 may be assigned to lengths with higher hardness(yellow), 3 may be assigned to lengths with thicker than nominal wall (yellow), and 1 to lengths with nominal material (green—preferred length to close the rams). Furthermore, at least one computer 20 may monitor the string weight through data acquisition system 35 to determine if the drill pipe 7 is under tension or compression. The optimal condition to shear the drill pipe 7 is when body wall it is centered in the shear rams, under tension and with nominal or less hardness and wall thickness. The driller's display may then combine all such data in a simplified color scheme appropriate for an emergency. Preferably, the emergency driller's monitor would be separate from the other monitors and will not use overlapping windows, as a critical but rarely used window may be hidden behind a more often used window. In addition to the display, at least one computer 20 may utilize stored expert knowledge, sound, voice and speech recognition to aid or even guide the driller in case of an emergency.

It should be understood that if part or the whole drill string is replaced by a higher strength drill string, AutoCV will detect the change and assess automatically the drilling system using the new drill string data.

It should also be understood that the lengthwise drill pipe lengths are in reference to the surface AutoCV 10A assessment head 12. At least one computer 20 through data acquisition system 35 may measure Deployment Parameters such as, but not limited to, angle, direction, distance, heave, position, location, speed and similar items to calculate instantly the location of the surface assessment head 12 in reference to other locations such as the BOP 8 rams or a dog-leg and therefore reference said flagged lengths to said other locations. This calculation may be utilized alone and/or may provide a backup for the subsea AutoCV 10C when one is deployed. In addition, AutoCV may calculate the drill pipe stretch using measured Deployment Parameters and Historical data.

The above is an example of how AutoCV may use data from one system component, the as-is drill string for example, to examine its impact on the overall system. Another unique and novel feature of the present invention is that it may also assess the impact of the overall process upon a component. For example, computer 20 may monitor, log and evaluate the overall drilling performance and its impact on the MUA by measuring the power consumption of the drilling process, the string weight, weight on bit, applied torque, penetration rate and other related parameters. Such information, an indication of the strata and the efficiency of the drilling process, may be processed and used as a measure to further evaluate and understand the impact of the process upon the MUA, the as-is drill string imperfections, FFS and RULE.

Optimizing a Process

In addition, MUA is part of a system which, most likely, is part of a process. For example, a pitot tube is after all part of the flight from Rio to Paris. This failure-chain is fairly easy to establish.

The components involve the Pitot Tube working, who is flying the plane, whether the AircraftAutopilot Pilot is used and has a recovery procedure built into software, training for RecoveryOverspeed, and similar factors.

The worst Failure-chain then is: {No (Pitot Tube not working), Unknown (no other type of air speed indicator), Off (disconnect auto pilot), Passenger flying the airplane, No training for recovery/overspeed, and no software built into the auto pilot for overspeed/recovery or to provide help to the flight crew} while the particular Failure-chain was {No, Unknown, Off, Trainee, No, Yes}. This Failure-chain could have been disrupted with adequate airspeed backup indicator of different type, with a Senior Captain in the controls, with training of the flight crew to recover from the pitottube failure, with a recovery procedure programmed in the Autopilot or even the computer advising the flight crew on probable causes and suggesting recovery techniques. It should also be noted that AutoCV could utilize an accelerometer and/or other sensors to measure the sharpness of the storm jolts and bumps and convert them to an estimated aircraft (or watercraft) speed. After all, the Autopilot did detect the failure and disconnected instead of advising the crew of a recovery procedure(s) while monitoring critical flight data. Furthermore, review of historical data revealed that these particular pitot tubes freeze with increased frequency during a storm in the Intertropical Convergence Zone where the disaster occurred. An Assessment would then have concluded that the pitot tube heaters were not sufficient, also disrupting the failure-chain. Flying around the storm would also have disrupted the Failure-chain but it would have delayed the flight and consumed more fuel.

Again, this failure-chain can easily be translated to a numerical string, such as {10, 10, 10, 6, 10, 10} where 10 represents the worst possible scenario, 6 represents a trainee and 1 represents the best possible scenario. One may add 8 for flight through the Intertropical Convergence Zone resulting in {8, 10, 10, 10, 6, 10, 10}. It is clear from this numerical string that this was a disaster waiting to happen. A backup speed sensor adept to harsh conditions or a more powerful heater would change the numerical string to {8, 10, 1, 1, 6, 10, 1} disrupting the failure-chain. This is also an example of using identical systems as a backup resulting in a double or triple failure, not increased reliability and safety. Another example is stacking two or three BOPs d on top of each other that will fail simultaneously when dealing with high strength pipe resulting again in a double or triple failure, not increased reliability and safety.

AutoCV Operable Model

Another unique and novel feature of the present invention is the functional model of the as-is MUA that may be operated by the software. For example, the software may close and open a BOP 8 ram (will operate the software model of BOP 8) and verify that the as-is BOP 8, under the measured Loads and Deployment Parameters, is still operable. This involves at minimum, assembling a system using preferably the as-is components; calculating the effects of the Loads and Deployment Parameters on each component and verifying that there is no undue deterioration or interference between the components during the operation.

For example, when two concentric tubes slide in reference to each other, the model operation may be limited to examining the ODs of the inner and the IDs of the outer tube using the corresponding string arrays, all referenced to a common centerline. For simplicity, the model operation may be carried-out using a 2D cutout comprising of the minimum outer ID and the maximum inner OD as shown below.

{5.007, 5.009, . . . 5.006, 5.004} ID of outer tube (minimum values)

{4.999, 5.003, . . . 5.001, 4.998} OD of inner tube (maximum values)

However, the inner tube may be subjected to a fixed or, most likely, varying bending moment when it slides out. This action alone would fatigue and deform the inner tube over time. In addition, the inner tube may endure thermal-cycling along with the cyclic bending. A measure of the inner tube fatigue may be as simple as keeping track of the number of cycles, Loads and Deployment Parameters sufficient for the RULE calculation of the inner tube. It should further be understood that fatigue is not equally distributed throughout the material, so a conservative RULE value should be utilized until additional data is obtained following subsequent Assessment scans.

Furthermore, the extended inner tube (or rod) may be subjected to a corrosive environment resulting in additional deterioration. For example, during drilling, repeated scans of the drill pipe 7 may establish a measure for the corrosive environment. It would be safe to assume that the wellbore side of BOP 8 and the Risers 6 are subjected to the same environment leading to deterioration calculation for the exposed BOP 8 components and the ID of the Risers 6. These estimates may be further fine-tuned with subsequent Assessment scans and the findings may further be stored in a Longitude and Latitude reference for use in future drilling operations. This is another example of AutoCV assessing the impact of the overall process upon a component.

It is well known that material deterioration due to loading is magnified when the loads are applied in a corrosive environment. Particularly, the problem of fatigue cracks rapidly magnifies when the material is subjected to cyclic loading in corrosive environments. The environment the BOP 8, the drill pipe 7, the Risers 6 and the welds are exposed may change as the drilling progresses. Exposed rods of the BOP 8 or tensioner pistons may corrode slightly undermining the seals resulting in a hydraulic leak. This is an example of a subtle change that may impact the drilling equipment but it will go unnoticed until a failure occurs or an oil sheen is observed.

Preferably, AutoCV knows by some detail the components deterioration mechanism(s) and its effects over time or number of cycles etc. This knowledge may also be applied on the as-is model to calculate, for example, a BOP 8 shear-efficiency constant Kse and to create an as-predicted model, thus calculating FFS and RULE through a different path.

Preferably, the Deployment Parameters of MUA, along with the operable as-designed and as-built model will be stored onboard the AutoCV to facilitate an operational comparison of the as-is and/or as-predicted to the as-designed and/or as-built MUA model. It should be understood that on a subsequent Assessment, the new as-is model would be compared to the as-predicted model which would be appropriately updated.

BOP Assessment

The BOP 8 pressure rating only applies to the pressure containment vessel, not the valve closure mechanisms or the overall BOP 8 operation. Therefore, minimal 1D-NDI is performed on the pressure containment vessel, none of which takes into account the actual static and dynamic conditions the BOP 8 endures during deployment and especially during a blowout where the BOP 8 is the last line of defense. For example, subsea BOP 8 inspection does not account, among many others, for simple issues like the pressure and temperature difference between the outside of the BOP 8 (seafloor) and the inside of the BOP 8 (wellbore). Yet, this Deployment Parameters difference alone could even render the BOP 8 inoperable during deployment.

As a result, subsea BOPs fail to pass a “good test” 50% of the time, as documented by SINTEF, MMS and other organizations and studies. Following a SINTEF study of the Norwegian sector of the North Sea, MMS began a review of the BOP testing around 1993. MMS study determined that BOP failure rates were substantially greater than those recorded by SINTEF. Despite two decades of studies, MMS, API, SINTEF, DNV and other participants are not reporting any BOP performance improvement. The failure of the Deepwater Horizon BOP was consistent both with the industry observations/tests and the findings and reports of the regulatory agencies (like MMS, now renamed BOEMRE).

Where safety-critical high-reliability equipment is concerned, such as the BOP 8, the risk is increased significantly when sporadic 1D-NDI is used as a substitute for Assessment. Another faulty approach is the use ill-defined backup equipment as a substitute for a high-reliability Assessment. For example, stacking two BOPs, one on top of the other, may give a false sense of security and increased safety. However, both BOPs are typically made by the same manufacturer, both BOPs suffer from the exact same idiosyncrasies and shortcomings and both BOPs will fail exactly the same way when dealing with high-strength drill pipe or a drilling collar, a reliability problem that will never be solved by stacking BOPs. Therefore, backup systems do not necessarily result in a high-reliability fault-tolerant system because backup systems come with their own idiosyncrasies and shortcomings and they are more difficult to test. Failures of backup systems resulted in the Three Mile Island, Chernobyl and Fukusima disasters, all three of which could have been avoided with high-reliability Assessment methods and controls.

Therefore, meticulous Assessment of safety-critical high-reliability equipment, systems and processes should pave the way for the selection of backup. Selection of backup, following a meticulous Assessment, would most likely result in fine-tuned backup system(s) capable of recovering whole or partial functionality after a failure, such as the mid-level AutoCV 10B. Typically, a fine tuned backup system is less expensive to implement and does increase reliability and safety. On the other hand, ordering two of the same would most likely result in a double failure, not increased reliability and safety. For example, the A330 uses more than 2 pitot tubes that are also heated to avoid freezing and yet, it should be expected that all will fail the same way when the temperature drops below a certain level.

The “Fog-of-Emergency”

Lack-of-knowledge controls an emergency, particularly at the onset. Preferably, AutoCV would foresee a failure that may lead to an emergency through the Mathematical Description of the system and alert the operator before the failure occurs. However, AutoCV does not scan all of the system components continually and for some components AutoCV relies on predicting their deterioration through indirect rheans. Furthermore, an emergency may be the result of circumstances beyond the realm of AutoCV, such as another vessel colliding with a floating drilling rig. Even under those circumstances, AutoCV preferably would be programmed to aid the operator by lifting the Fog-of-Emergency within its realm (“Fog-Of-Emergency” or “FOE” are trademarks of STYLWAN). For example, if the mishap did not damage the drilling equipment, systems and process, the operator or other crew members could instantly access their status through the AutoCV with a simple “status” verbal command where the AutoCV will display and recite the status of critical parameters. This will enable the operator and crew to focus on other emergency issues, even away from the control room, with the AutoCV monitoring the drilling equipment, system and process and keeping in touch with operator and crew through the multiple remote communication links.

Preferably AutoCV will also be programmed to interpret the data and recognize the root-cause of an emergency or identify some most-likely causes. AutoCV would then be programmed to recite the findings to the operator and the crew and suggest corrective actions to disrupt the failure-chain. It should be understood that the operator may move to a safe(r) location and still stay in touch with AutoCV through speech, sound and the remote communication links. Furthermore, AutoCV access to remote experts may be utilized during an Emergency with the experts having access to all AutoCV data.

It should further be understood that AutoCV systems may be distributed throughout the rig as communication backups. For example, a failure or a fire may disable the rig floor AutoCV 10A, however, AutoCVs 10B and 10C would still be fully functional and capable of duplicating multiple AutoCV 10A functions therefore, the distributed communication capability may recover whole or partial AutoCV functionality. Subsea power is limited and expensive and therefore AutoCV may configure assessment heads 12 of AutoCVs 10B and/or 10C to function in a passive detection mode without inducing power consuming excitation or inducing reduced excitation during normal operation. After the failure though, AutoCV may instruct AutoCVs 10B and/or 10C to enter the active mode to safely perform an Emergency Disconnect Sequence (herein after referred to as “EDS”) for example.

In offshore drilling there may be a need for an emergency disconnect between a drilling rig and the sea-floor wellhead. In addition to an equipment failure, a dynamically positioned rig may no longer be able to maintain its position above the sea-floor wellhead due to inclement weather. A properly executed EDS allows the rig to move off location without damaging the subsea equipment and still maintaining control of the well. A typical EDS mandates that the drill string is picked up and hung off in the BOP 8 pipe rams. Thus, it becomes necessary to know the exact drill pipe length in the BOP 8 rams.

The present invention provides four different means to monitor the material inside the BOP 8 rams: a) Scanning the drill pipe with the rig floor AutoCV 10A and/or the mid-level AutoCV 10B and calculating the instantaneous drill pipe length in the BOP 8 rams using other Deployment parameters such as, but not limited to, angle, direction, distance, heave, position, location, speed and similar items; b) Monitoring the BOP 8 rams with the subsea AutoCV 10C; c) preparing the drill pipe on the surface for a BOP 8 rams passive tool joint monitor and d) utilizing a mid-level AutoCV 10B passive or active mode or a combination thereof. On the other hand, providing two surface AutoCV 10As would most likely result in a double failure, not increased safety and reliability. In this particular example, a simple and less expensive communicator(s) increased the safety and reliability.

It may be seen from the preceding description that a novel Autonomous Constant Vigilance system and control has been provided that is simple and straightforward to implement. Although specific examples may have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

A computer program may evaluate the impact of the MUA Features upon the MUA by operating on the MUA Features, said operation guided by a database constraints selected at least in part from knowledge and/or rules and/or equations and/or MUA historical data. The AutoCV system may acquire Loads and Deployment Parameters by further comprising of a data acquisition system. A computer program may evaluate the impact of the Loads and Deployment Parameters upon the MUA by operating on the MUA Features, said operation guided by a database constraints selected at least in part from knowledge and/or equations and/or rules. A computer program may convert the MUA data to a data format for use by a Finite Element Analysis program (herein after referred to as “FEA”), also known as an FEA engine, or a Computer Aided Design program (herein after referred to as “CAD”).

Regardless of the MUA name, which may comprise any of the above mentioned elements, AutoCV: a) scans the MUA to detect a plurality of Features; b) recognizes the MUA detected Features and therefore “knows by some detail” the MUA Features; c) associates and connects the recognized MUA Features with known definitions, formulas, risks and MUA historical data, preferably stored in a database; d) creates an MUA mathematical and/or geometrical and/or numerical description compiled through the mathematical, geometrical and numerical description of the MUA recognized Features (herein after referred to as “Mathematical Description”); e) converts the MUA recognized Features into a data format for use by an FEA and/or a CAD program; f) calculates Feature change-chain and compares with stored failure-chains for a match; g) calculates a remediation to disrupt the Feature change-chain (disrupt the failure-chain early on) and h) updates the MUA historical data database.

The MUA Mathematical Description is then acted upon by the theoretical Loads and Deployment Parameters, sufficient for calculating an MUA FFS and RULE to predict an MUA behavior under deployment in accord with an embodiment of AutoCV operation under various loads, for example the loads result in bends of the riser, pipe, or umbilical, for example depending on the length and water currents. Furthermore, the MUA Mathematical Description may be converted to an MUA functional model or prototype which may be operated to verify MUA functionality directly and/or through a CAD program and/or through an FEA program.

AutoCV assesses accurately the risk factors associated with the specific riser joint under the specific deployment loads and thus, it disrupts a failure-chain with exact knowledge that is continually updated.

In the event of an emergency, AutoCV preferably will announce the emergency and the corrective action in multiple languages preferably to match the native languages of all the crew members.

The flaw spectrum is then processed by a system of identifier equations, as illustrated in FIG. 3B, resulting in a Mathematical Description of the MUA compiled through the Mathematical Description of its Features. At least one computer 20 utilizes stored constraints and/or knowledge and/or rules and/or equations and/or MUA historical data to identify the nature and/or characteristics of MUA Features so that at least one computer 20 knows by some detail the MUA Features and connects and associates the MUA Features with known definitions, formulas, Mathematical Description, FEA, CAD and similar items resulting in Identification Coefficient(s) Ki. It should be understood that Ki may be a number and/or an equation, an array of numbers and/or equations, a matrix, a table or a combination thereof (see Page 24)

At least one computer 20 further calculates and verifies that the MUA is operating within the safe-operating zone(s) of the operational-envelop.

Furthermore, comparison of historical data similar strings and Failure-chains may reveal a Feature change, a Feature morphology migration, a Feature propagation and the calculation and identification of a subtle change-chain that matches an early stage of at least one of stored Failure-chains that may be disrupted through remediation before it progresses to a Failure-chain and eventually to an Accident-chain.

Computer 20 may further calculate a simpler flaw spectrum by combining all Features of a section, such as a circumference, into an equivalent flaw spectrum using Ki, Kn, Kf coefficients, stored formulas, charts, tables and historical data.

FIG. 4 illustrates the MUA resulting simpler flaw spectrum, a Critically-Flawed-Path (Herein after referred to as “CFP”) (Critically-Flawed-Path and CFP are trademarks of STYLWAN). It should be understood that there is no physical correspondence between the CFP and the MUA Features as CFP is a mathematical construct that only preserves the MUA performance.

It is a unique feature of the present invention that the Mathematical Description of the MUA may be further manipulated to address system specific requirements and to optimize the system operation.

While tripping out of the well, AutoCV 10A would then scan the drill pipe 7 and compare the actual Features, FFS and RULE to the predicted Features by the Assessment while drilling and fine tune the Assessment through these continuous measurements.

It should also be understood that the lengthwise drill pipe lengths are in reference to the surface AutoCV 10A assessment head 12. At least one computer 20 through data acquisition system 35 may measure Deployment Parameters such as, but not limited to, angle, direction, distance, heave, position, location, speed and similar items to calculate instantly the location of the surface assessment head 12 in reference to other locations such as the BOP 8 rams or a dog-leg and therefore reference said flagged lengths to said other locations. This calculation may be utilized alone and/or may provide a backup for the subsea AutoCV 10C when one is deployed. In addition, AutoCV may calculate the drill pipe stretch using measured Deployment Parameters and Historical data.

The above is an example of how AutoCV may use data from one system component, the as-is drill string for example, to examine its impact on the overall system. Another unique and novel feature of the present invention is that it may also assess the impact of the overall process upon a component.

It should also be noted that AutoCV could utilize an accelerometer and/or other sensors to measure the sharpness of the storm jolts and bumps and convert them to an estimated aircraft (or watercraft) speed.

Another unique and novel feature of the present invention is the functional model of the as-is MUA that may be operated by the software. For example, the software may close and open a BOP 8 ram (will operate the software model of BOP 8) and verify that the as-is BOP 8, under the measured Loads and Deployment Parameters, is still operable. This involves at minimum, assembling a system using preferably the as-is components; calculating the effects of the Loads and Deployment Parameters on each component and verifying that there is no undue deterioration or interference between the components during the operation.

AutoCV would then be programmed to recite the findings to the operator and the crew and suggest corrective actions to disrupt the failure-chain.

It should be understood that the present invention Assessment of complex MUA (complex system) starts with the complex MUA analysis to define the operational-envelope of the sub-systems and the components and then, to define failure-chains. It may take multiple iterations to complete this first step. Then, Assessment scans and measures the components with sufficient resolution so that Assessment knows by some detail the as-is component structure, its Fit-ness-For-Service (herein after referred to as “FFS”) and its Remaining-Useful-Life (herein after referred to as “RUL”) within its operational-envelop. FFS estimation is herein after referred to as “FFSE” and RUL estimation is herein after referred to as “RULE”. Assessment then closes the loop by starting from the simplest components and progress upwards in complexity. Assessment may assemble and assess an as-is sub-system and eventually the complex MUA by assembling the as-is components into an MUA functional model.

For example, an offshore drilling rig is a sea going vessel that comprise of most MUA listed above including, but not limited to BOP, casing, CT, DP, engine, pump, Riser, structure, tensioner each further comprising, at least in part, of simpler components such as beam, enclosure, fastener, frame, piston, rod and tube.

Loads act upon the “as-built” and/or “as-is” MUA features impacting its FFS and RULE. A list of MUA features includes, but is not limited to, ballooning, blemish, blister, boxwear, coating, collar, corrosion, corrosion-band, coupling, crack, crack-like, critically-flawed-area (herein after referred to as “CFA”), critically-flawed-path (herein after referred to as “CFP”), cross-sectional-area (herein after referred to as “CSA”), defect, deformation, dent, density, dimension, duration, eccentricity, erosion, fatigue, flaw, geometry, groove, groove-like, gauge, gauge-like, hardness, key-seat, lamination, loss-of-metallic-area (herein after referred to as “LMA”), metallic-area, mash, misalignment, neck-down, notch, ovality, paint, pit, pitting-band, pit-like, profile, proximity, rodwear, scratch, seam, sliver, straightness, stretch, surface-finish, surface-profile, taper, thickness, thread, threaded-connection, tool joint, wall, wall-thickness, wall-profile, wear, weld, wrinkles, a combination thereof and similar items, (herein after referred to as “Features”).

An MUA Feature that was not in the MUA design is herein after referred to as “Imperfection”. Imperfections are undesirable and often arise due to fabrication non-compliance with the design, transportation, deployment conditions, mishaps and MUA degradation. An Imperfection that exceeds an alert-threshold is herein after referred to as “Flaw”. Typically a Flaw places the MUA in the category of in-service monitoring. An Imperfection that exceeds an alarm-threshold is herein after referred to as “Defect”.

In addition, it should be understood that even MUA that is free of any damage may still be unfit for service in a particular application and/or deployment as design assumptions and/or knowledge, such as Mean-Time-Between-Failures (herein after referred to as “MTBF”) and similar measures and/or statutory requirements, and/or operating conditions and/or mishaps may render the MUA unfit for service. This is the reason FFS and RUL estimation should preferably monitor and/or measure MUA deployment parameters, a non-limiting list involving one or more of absorption, AC parameters, acceleration, amplitude, angle, brittleness, capacitance, conductivity, color, critical-point temperature, cyclic loading, DC parameters, deformation, density, depth, diameter, dimension, direction, distance, ductility, ductile-brittle transition temperature, eccentricity, eccentric loading, echo, flow, flow rate, fluid level, force, frequency, geometry, impedance, heave, horsepower, image, impedance, impulse, inductance, length, loads, load distribution, location, longitude, misalignment, moments, motion, number of cycles, number of rotations, number of strokes, opacity, ovality, penetration rate, permeability, ph, phase, plastic deformation, position, power, power consumption, pressure, propagation, proximity, radius, reflectivity, reluctance, resistance, rotation, rpm, shear, size, sound, specific gravity, speed, static loading, strain, stress, temperature, tension, thermal loading, torque, torsion, twisting, velocity, vibration, volume, wave, weight, weight on bit, width, relative values of the above, combinations of the above and similar items (herein after referred to as “Deployment Parameters”).

Maintenance

Typically MUA is maintained on an interval, such as time or number of cycles, commonly referred to as preventive maintenance. Predictive maintenance theoretically uses a data analysis to determine when the MUA requires maintenance. Theoretically, this approach appears to be more efficient and cost effective. In practice however, predictive maintenance requires MUA diagnostic data and detailed knowledge of the MUA deployment loads that, at best, are difficult and/or expensive to obtain resulting in over maintaining MUA that does not need maintenance and under maintaining MUA that does need maintenance. Predictive maintenance is not a realistic option for most MUA and would most likely result in repair maintenance because of the lack of useful data. Repair maintenance refers to MUA that is used until it fails. Lack-of-(detailed) knowledge of the as-is MUA n is the weakest link among all the maintenance programs which primarily rely on inspection, such as Non-Destructive Inspection (herein after referred to as “NDI”). NDI is also referred to as Non-Destructive Evaluation and as Non-Destructive Examination, both shortened to “NDE” in the literature.

The following further provides additional information regarding use of the present invention with risers and umbilicals as used in offshore operations so that the Riser stress-engineering-assessment equipment, referred to herein as “RiserSEA, is a more specific embodiment of Autonomous Constant-Vigilance System, referred to herein as AutoCV.

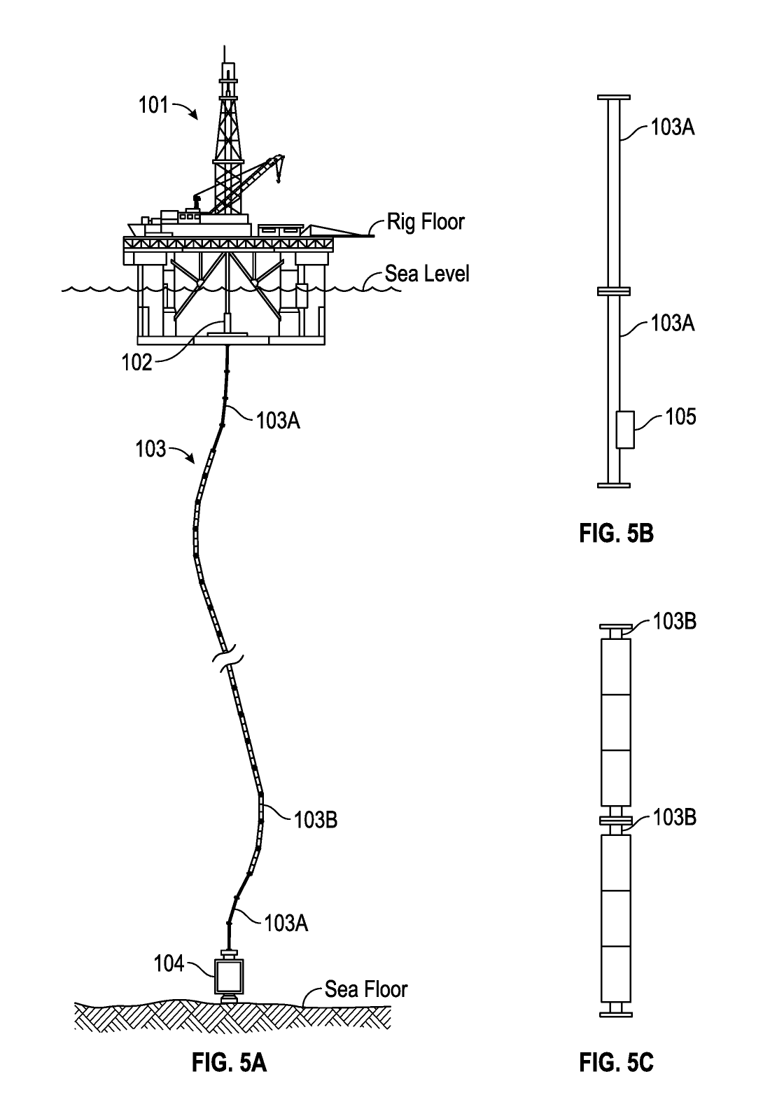

Referring now FIG. 5A, FIG. 5B, and FIG. 5C, there is shown a floating drilling rig 101 with a Riser string extending to the blowout preventer 104. For illustration purposes the Riser string comprises of the telescopic joint 102 and Riser joints 103. Riser joints comprise of joints without buoyancy 103A, joints with buoyancy 103B and joints with instrumentation 105. During deployment, the Riser string may be treated as a slender flexible structure without inherent stability.

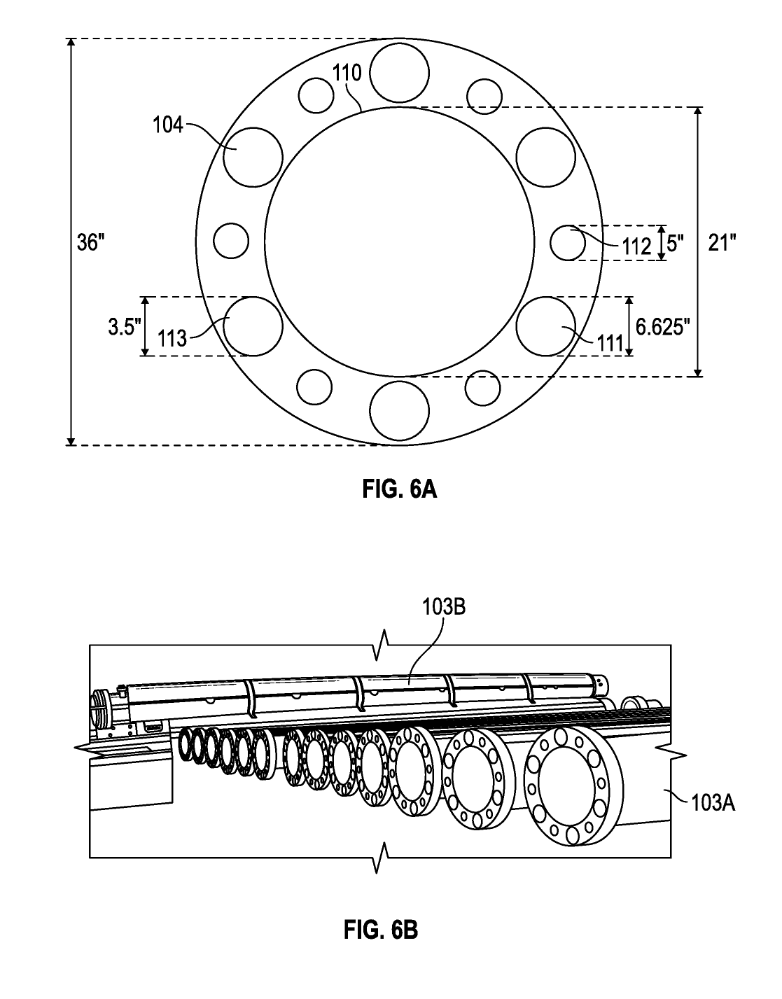

FIG. 6A and FIG. 6B illustrates the end area (coupling) of a typical marine drilling riser joint comprising of the main tube 110, hereinafter referred to as “MT”, and the auxiliary lines, hereinafter referred to as “AUX”. The AUX lines comprise of the Choke and Kill lines 111 hereinafter referred to as “C&K”, the Booster line 112 and the hydraulic line 113. Riser joints without any AUX lines or different combinations of AUX lines are also in use.

A Riser under deployment is subjected to multiple static, dynamic, transient and cyclic Loads from applied tension, pressure, rig motion, sea currents, weight of fluids and gases (drilling, production, control), waves, wind and similar items, in addition to the biological, chemical, electrochemical and mechanical actions of the environment and the drilling, control and production fluids and gases, hereinafter after referred to as “Actions”. Actions are mostly time dependent deterioration processes excluding accidents, such as a collision. The utilization of Risers in greater water depths amplifies significantly the effects of the Loads and Actions. Calculation details that until recently could be omitted, are now becoming important. However, the Riser 1D-NDI spot-checks and analysis still relies on old concepts, addressing old materials that do not reflect the modern day needs of deepwater Riser deployment and use.

A partial list of variables that influence the Riser integrity comprise of: a) Pressure; b) Geometry (diameter, wall thickness, ovality); c) material properties such as composition, yield strength and other; d) shape and neighborhood of Imperfections and e) Loads and Actions.

As the water depth increases, Riser designs share the Loads between the MT and the AUX, thus significantly complicating the RiserSEA that should also calculate the MT and AUX multidimensional stresses corrected for the MT and AUX material properties and geometry.

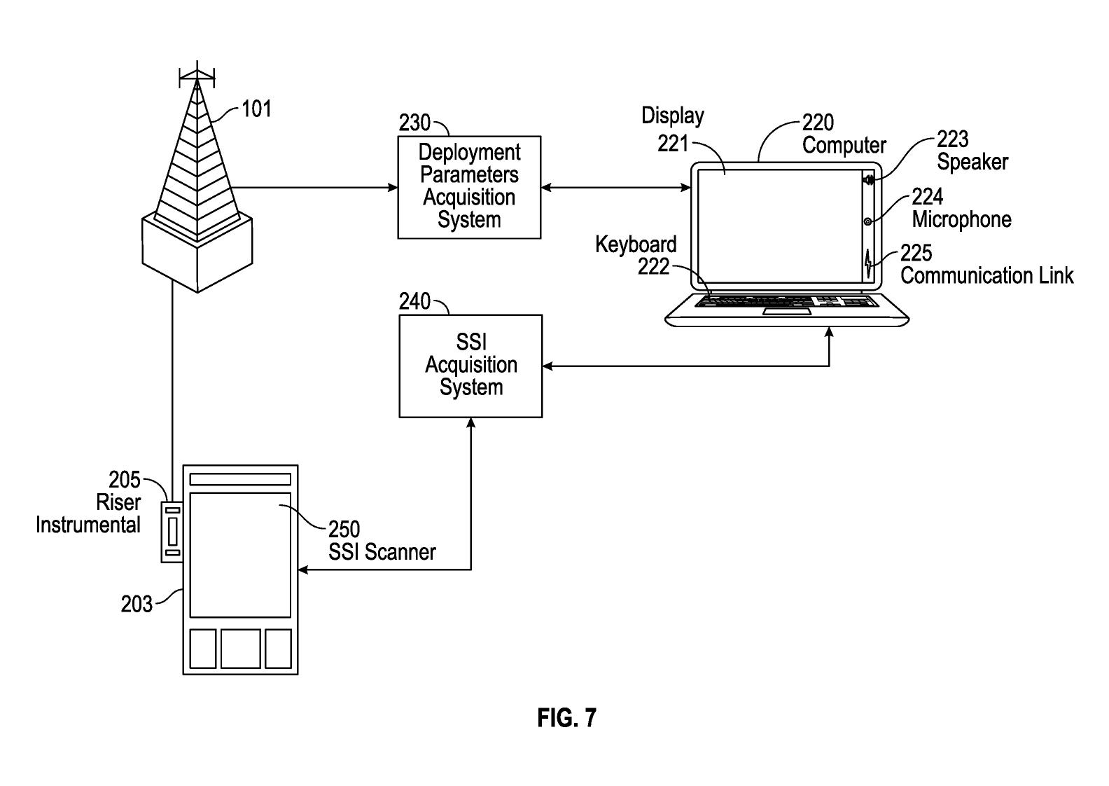

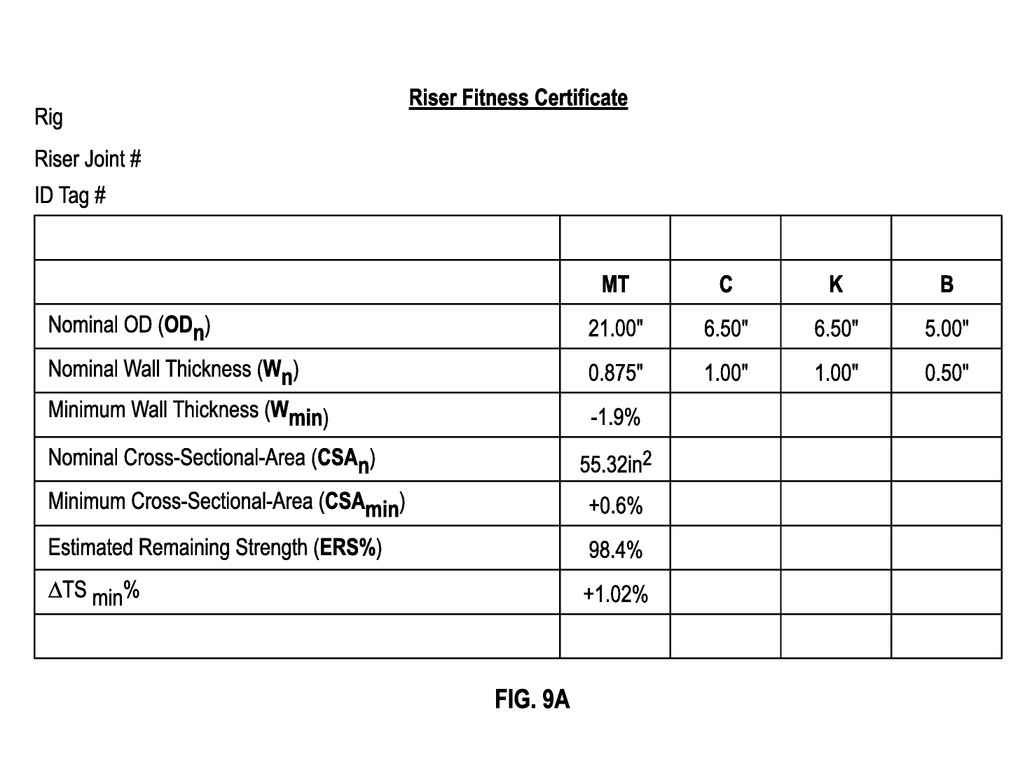

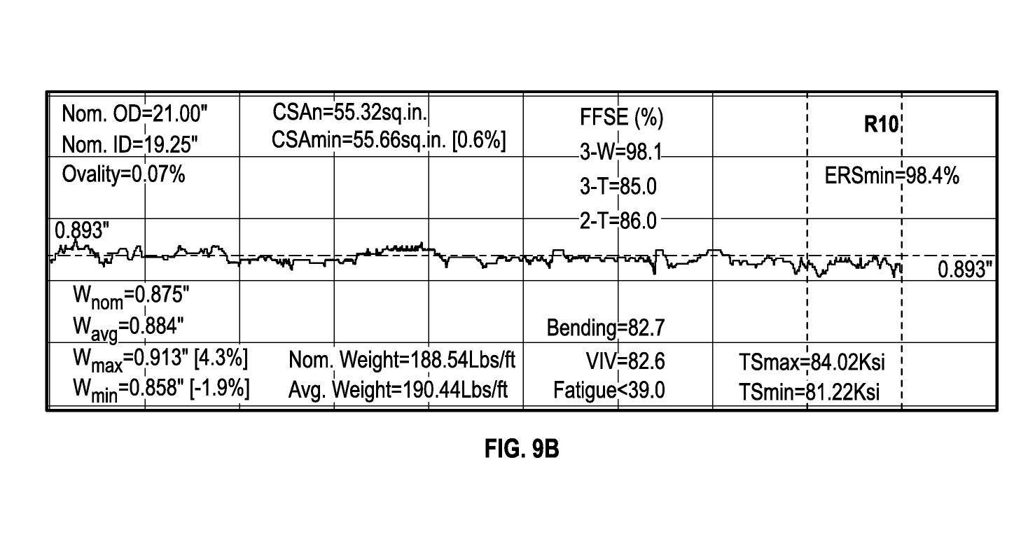

FIG. 7 illustrates one embodiment of the RiserSEA comprising of at least one computer 220, at least one deployment parameters acquisition system 230 and at least one stress-significant-imperfection (hereinafter referred to as “SSI”) acquisition system 240. Examples of deployment acquisition system 230 and acquisition system 240 are shown in my previous patents. In this example, riser 103, which are types of risers 103A or 103B, is being examined, typically each tube of one riser at a time with each of the risers separate and available for examination, such as at a depot as indicated in FIG. 6B. SSI scanner 50 is run through each of the tubes 110, 111, 112, and 113 of each riser. Once this is done, the combination of information can be utilized as explained above, to determine the fitness of the riser (or umbilical), what type of bends it can sustain, whether it should be removed or possibly placed where less bending will occur. This process could involve transporting the mathematical description of the riser to an FEA model where an analysis is made utilizing anticipated stresses applied to the riser. Using such an analysis, or other measurements, a Riser fitness Certificate can then be issued based on the results of the testing as indicated in FIG. 9A. In FIG. 9A, it will be seen that wall thickness is measured for each tube (such as center tube 110), minimal wall thickness variations, cross-sectional variations, estimated remaining strength, and the like.

It should be understood that SSI detection may include, but is not limited, to the API 16F “geometric stress amplifiers” and ASME B31.4 “stress intensification factors”. Computer 220 comprises of a local and/or remote display 221, keyboard 222, permanent or removable storage, local and/or remote speaker 223 and/or earphone, local and/or remote microphone 224 and at least one communication link 225. The deployment parameters acquisition system 230 and SSI acquisition system 240 monitor sensors distributed around the rig 1, including but not limited to acoustic, barcode, chemical, color, conductivity, current, deformation, density, depth, density, direction, distance, eddy-current, electrical, EMAT, field, flow, flux-leakage, force, frequency, geometry, laser, length, level, location, motion, magnetic, optical, physical properties, pressure, rate, rfid, reluctance, resistance, rig motion, rpm, speed, stress, temperature, time, vibration, voltage, weight, similar items and combinations thereof and/or along with the instrumentation 205 on the riser joints.

Instrumentation 205, if utilized, comprises sensors for the above listed items that measure these items on the deployed risers so that instrumentation 205 effectively comprises SSI sensors. Wiring connections, umbilicals, acoustic mud modems, and the like, may be utilized to connect to/from RiserSEA surface processors 220 (or processors in AutoCV 10A, 10B riser processors, 10C subsurface processors) and the instrumentation 205 in the risers/umbelicals.

In one embodiment, each riser or selected risers in the riser string would include an instrumentation 205. At a minimum, the instrumentation 205 could be used to determine the overall angles of the deployed riser string and/or stresses on the riser string 3 as indicated by the bends shown in FIG. 1 or FIG. 5A. The SSI acquisition system 40 may induce programmable excitation into the SSI scanner 50 and monitor the SSI sensors.

Solving the Elasticity Equations

The main function of RiserSEA is to calculate Riser stress and strain. In the study of elasticity, stress and strain are typically expressed as systems of (x, y, z) partial differential equations that can be found throughout the literature along with some solutions using boundary conditions. A simpler approximation is to replace the partial differential equations with partial difference equations as published by C. Runge (Z. Math. Phys. Vol. 56, p. 225, 1908) or, preferably, even simpler equations or look-up tables. Reference 3, Appendix C “Compendium of Stress Intensity Factor Solutions” provides a number of practical approximations and solutions.

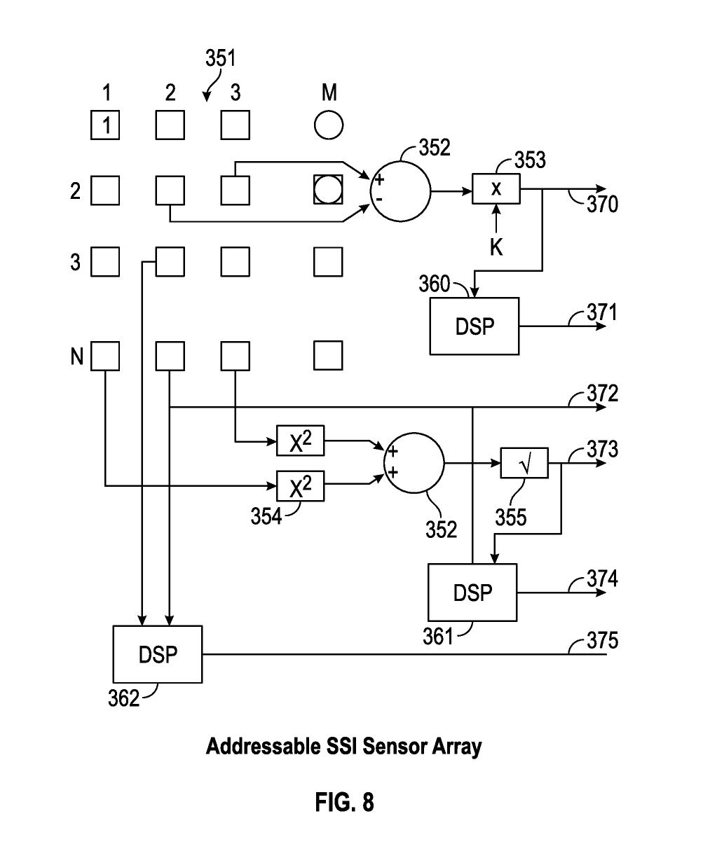

The selection of the RiserSEA sensors and sensor configuration 351 for SSI scanner 350, shown in FIG. 8, starts by defining the SSI parameters that are Riser integrity-significant and stress-significant. This involves solving the stress equations for the multitude of SSI parameters and defining the minimum value(s) to be detected early on so preventive maintenance can be effective. This may involve FEA, test samples, experimentation or a combination thereof.

Therefore, the main function of computer 220 is to acquire a sufficient number of good quality specific SSI data from the sensor array of SSI scanner 350 through the SSI acquisition system 240 (see for example our prior applications for more details); to process and translate the data to an individual Riser 103 or other OCTG description; store said description in a lengthwise format; derive the Riser 103 boundaries; acquire Riser 103 deployment parameters through the deployment parameters acquisition system 230 and solve the elasticity equations to decide if Riser 103 is still fit for deployment in a string location, should be moved to another string location, should be re-rated, should be removed from deployment for remediation or be retired from service. Computer 220 may further suggest the type of remediation to return Riser 103 to service.

FIG. 8 illustrates a M×N addressable two-dimensional (hereinafter referred to as “2D”) sensor array 251 of physical sensors, hereinafter referred to as “Sensors” or “SM,N”, preferably installed on the inside or outside of the SSI scanner 250 or both. It should be understood that M and N represent the number of sensors that provide 100% inspection coverage and, therefore, the greater the OCTG size the greater the number of sensors for constant resolution. A three-dimensional (hereinafter referred to as “3D”) sensor array comprises of at least two stacked sensors, such as SM,2, or a partial or complete 2D sensors arrays. 3D sensors are addressed as SL,M,N. The sensor arrays are preferably deployed with length measurement or time measurement converted to the length of the Riser pipe or other OCTG. In other words, scanner 250 is lowered through each tube 110, 111, 112, 113 of each individual riser such as when the risers are on the surface.

It should be understood that a particular sensor array 251 may comprise similar or different types of sensors and that each type of sensor may require a different type of fixed or programmable excitation from the SSI acquisition system 240. The excitation may be deployed inside SSI scanner 250, may be separately applied on the inside or outside of Riser 103, may be applied as a bias prior to the scan or any combination thereof. It should further be understood that the fixed or programmable excitation and the Sensors may be disposed on the inside of a Riser 3 pipe(s), the outside of a Riser 3 pipe(s) or any combination thereof

Configuring the Sensor Array

Each inspection technique has advantages and disadvantages. Most require thorough cleaning of the Riser 103 and/or the removal of paint/coating and the re-application of paint/coating after the inspection. Again, this generates air and water contaminants in addition to high cost and low productivity. Once the inspection technique and the sensor(s) are selected, a number of Riser test samples with a number of pertinent preferably natural or man-made SSI may be used to define the excitation, sensor(s) mounting, detection range, sensor array configuration and the required signal processing. The sensor(s) excitation, detection range, the SSI sensor array configuration and signal processing Would then define the spacing among sensors and the overall configuration of the sensor array 251. It should be understood that this process may be fine-tuned through a number of iterations.

Sensor Array Signal Processing

Computer 220 signal processing may address, read and combine signals from any of the Sensors from array 250 as shown in Equation 1 (70) through Equation 4 (73) resulting in virtual sensors, hereinafter referred to as “VSensor” or “VSN”.

VS(70)=K*(S3,2−S2,2) (Eq. 1)

VS(01)=S3,1+S3,2+ . . . +S3,N (Eq. 2)

VS(01avg)=VS(01)/N (Eq. 3)

VS(73)=√[(SN,1)2+(SN,3)2] (Eq. 4)

Equations 1, through 4 and other equations may be a) hardwired using analog components such as amplifiers, filters, adder/subtractor 252, multiplier/divider 253, integrator/differentiator, similar items and combinations thereof; b) analog computers such as the [254, 252, 255] processing array; c) implemented in software by a digital signal processor (60) with at least one analog front end, hereinafter referred to as “DSP”; d) implemented with field-programmable-gate-array, hereinafter referred to as “FPGA” or any combination thereof. Constant K may be of fixed value, variable value through a potentiometer, variable or fixed value under computer 220 controls or DSP 260 control or any combination thereof.

The VSensor signals preferably correspond to different types of SSI and/or may form a system of equations that allows for the calculation of SSI critical parameters. It should be understood that certain physical sensors may be omitted, be replaced by VSensors or any combination thereof. For example, VS (273) may be an adequate replacement for S (N, 2) thus eliminating physical sensor S (N, 2), or allowing for a different type of sensor to be installed in the physical location S (N,2) generating signal 272. The relationship of Signals 272 and 273, generated by different types of sensors that are focused on the same location, may provide additional detailed knowledge about the material condition through the solution of a system of equations.

It should also be understood that sensor processing similar to the [VS(273), 272] pair or any other combination thereof may be reproduced in all three dimensions, thus giving rise to systems of multiple equations focused on specific material locations or material characteristics. For example, S(2,2) may be reproduced in one direction by √[(S2,1)2+(S2,3)2] and in another direction by √[(S1,2)2+(S3,2)2], the combination of all three signals giving rise to a another system of equations and a more-focused VSensor. Small area resolution requires fine-focus sensors, physical or virtual, that may be calculated by combining adjacent physical sensors such as above or even more focused such as the VSensor √[(S2,1)2+(S2,2)2].

It should be apparent from the above that finer resolution results in a higher number of systems of equations that must be solved simultaneously and therefore, finer resolution requires much higher processing speed. It should also be understood that not all signals are useful all the time. For example, in one instance signal 270 may be meaningful and significant while in another instance signal 275 may be meaningful and significant. Instead of relying on computer 220 for the entire signal processing, a distributed approach, as shown in FIG. 4, is a preferable method to increase processing speed. For example, instead of computer 20 digitizing and processing signals 272 and 273, a local DSP 61 may digitize and process the signals and alert computer 220 only when signal 274 is meaningful and significant. It should also be understood that a single FPGA may comprise of multiple DSPs.

Again, it should be understood that the sensor array would comprise of a sufficient number of sensors and processing elements to provide 100% inspection coverage and, therefore, the greater the OCTG size the greater the number of sensors for constant resolution. It should further be understood that the number and configuration of Sensors 51 and signal processing should acquire a sufficient number of good quality specific data to facilitate the RiserSEA calculation of maximum stresses and strains. Computer 20 may further use the DSPs 60, 61, 62 for fast processing of the stresses and strains.

Sensor Array Assembly

Metallurgy and fatigue signal comprise critical SSI parameters. They are mostly very low magnitude, typically order(s) of magnitude lower than signals from visible Imperfections. In order to detect and recognize such critical signals, the Sensor array must maintain a constant 3D relationship with the excitation inducer, a constant 3D relationship among the Sensors, a constant 3D shape and preferably exhibit no resonance frequencies within the range of SSI. It should be noted that the ride chatter of the sensors in U.S. Pat. No. 2,685,672 overshadows the metallurgy and fatigue signals. The ride chatter is the result of the spacing variations between the sensor and the material.

The final RiserSEA sensor array 251 configuration would most likely be complex resulting in a complex sensor holder that is best manufactured through machining, molding, additive manufacturing, similar techniques and combinations thereof. The sensor holder may comprise of a single or multiple segments. Additive manufacturing, such as using a 3D printer, allows for greater assembly flexibility, customization and rapid production. For example, the 3D printer may be paused; dimensions may be measured and adjusted; components, including but not limited to cooling, electronics, heating, hydraulics, pneumatics, sensor(s), storage and wiring may be installed; 3D printing may resume and be paused again for adjustments and the installation of additional components and so on and so forth until the Sensor array or a segment is completed.

The testing and qualification of the completed Sensor array may include but is not limited to detection testing, electrical testing, environmental testing, isolation testing, insulation testing, mechanical testing, scanning speed testing, and testing for resonance frequencies similar tests and combinations thereof. These tests would result in calibration coefficients that normalize the performance of the Sensor assembly including, but not limited to, resonance frequencies correction factors. The Sensor calibration coefficients may be stored on non-volatile storage onboard the Sensor array, on portable storage, on an on-line secure database, similar items and combinations thereof.

System Signal Processing

Again, computer 220 would preferably assemble and solve the Riser 103 elasticity equations using the good quality specific data that are sufficient in number to facilitate the RiserSEA calculation of maximum Riser stresses and strains.

Good Quality Specific Data: The selection of the RiserSEA sensors and sensor configuration 251 starts by defining the minimum SSI parameters that is stress-significant. This involves solving the stress equations for the multitude of specific SSI parameters and defining the minimum value(s) to be detected. It should be noted that the remaining-wall-thickness alone is just one of the parameters, not the ultimate decision yardstick.

Good Quality: Refers to data resolution, such as pre-processing, sampling rate, the analog-to-digital conversion bits and SSI detection repeatability. It should be understood therefore that the definition of good quality is Imperfection specific.

Sufficient number of Inspection. Data: A Sufficient Number of good quality specific data refers to Inspection Coverage, the volumetric percent coverage of each Riser pipe and subsystem. Inspection Coverage preferably may be defined by the combination of minimum SSI parameters to be detected, the detection sensor configuration and the desired scanning speed (one of the financial considerations along with the transportability and ease of deployment of the RiserSEA equipment).

Often, the inspection technique and/or the detection sensors are the controlling factors that redefine the minimum SSI parameters that can be detected. The minimum detectable SSI parameters are preferably defined as a geometric function of wall thickness (T) like (0.05*T) L×(0.05*T) W×(0.1*T) D (Length, Width and Depth) that may then be translated to a VSensor equation(s). The following examples discuss the Inspection Coverage of a 21.0″ OD, 75′ length MT with 0.750″ wall thickness. The inspection is performed from the ID:

Sensor overlap method: A 20% sensor reading overlap with a 0.5″ diameter sensor (typical Ultrasonic sensor) results in one reading every 0.4″ or a total of about 346,500 readings for 100% MT inspection coverage.

Minimum SSI dimensions: Assuming that the minimum SSI dimensions were calculated as 1.0″×1.0″×0.05″, it would translate to about 109,800 readings for 100% MT inspection coverage.

Number of readings per minimum SSI: It is preferable that a minimum of 2 readings per minimum SSI are obtained resulting in about 219,600 readings for 100% inspection coverage (from the ID). The minimum number of readings threshold is typically set between 5 and 9 in order to eliminate false sensor readings.

API 579-1/ASME FFS-1 formula 4.1: Although 4.1 addresses General Metal Loss, not stress analysis, it could be used as a starting point resulting in one reading every 1.29″ or about 33,500 readings for the detection of MT general Metal loss. Requiring a minimum of 20% sensor overlap would result in about 52,400 readings. Requiring a minimum of 2 readings would result in about 105,000 readings for 100% MT inspection coverage.

Once the number of sufficient readings is established, the scanning speed (production rate) may be calculated from the data acquisition speed of the RiserSEA or the RiserSEA may be designed to meet the required scanning speed. Again, one way to increase the production rate (scanning speed) is through distributed signal processing whereby analog computers, discreet logic; DSP(s), FPGA(s) and ASIC process certain signals, solve certain equations or any combination thereof as shown in FIG. 8.

As discussed earlier, RiserOEMs preferably take four (4) Ultrasonic wall thickness readings (90o apart) around the MT circumference every two (2) to five (5) feet of length. The maximum number of readings on a 75′ joint MT would then be 152 readings, four readings every 2′; indeed an insufficient Inspection Coverage for stress-analysis or even General Metal Loss fitness calculations.

Calculating Stresses

A unique and novel feature of the present invention is the tuning of the Sensor 250 configuration and excitation, the signal pre-processing, the sampling rate and the final processing to the specific characteristics of SSI Imperfections to facilitate and optimize the solution of the stress and strain equations by substituting the equation(s) variables with processed sensor signals. For example, the CSA of each Riser joint MT may be calculated from the inspection data by one or more of VS(01) (Eq. 2), VS(01avg) (Eq. 3) and other equations using absolute, aver-age, corrected, coverage, differential, integral, local, maximum (peak), minimum and remaining values, rate of change values, time dependent values, similar items and combinations thereof. Again, the calculated CSA and other calculated values of each Riser joint may be stored in a lengthwise array in computer 20 memory. Rate of change values, time dependent values and other ratios, differences, propagation and similar items may be calculated from the stored Riser joint lengthwise arrays of prior inspections.

In another example, stress is defined as (σ=Force/Area); where Area may be substituted by the calculated CSA of each Riser joint. Force may comprise of one or more of bending, buckling, compression, cyclic loading, deflection, deformation, drilling induced vibration, dynamic linking, dynamic loading, eccentricity, eccentric loading, elastic deformation, energy absorption, feature growth, feature morphology migration, feature propagation, impulse, loading, misalignment, moments, offset, oscillation, plastic deformation, propagation, shear, static loading, recoil, strain, stress, tension, thermal loading, torsion, transient loading, twisting, vibration, vortex induced vibration and a combination thereof. A force, such as tension, may be monitored in real-time by deployment parameters acquisition system 30, thus, by monitoring the Riser instantaneous tension, the instantaneous stress may be calculated for each Riser joint in the string. Alarm(s) may be raised when the calculated stresses exceed preset levels.

The stored CSA values along with all other stored values of each Riser joint may be used to arrange the Risers into a Riser string. When the string configuration is completed, computer 20 may automatically create a string model using the joint identification and its location in the string translated to water depth. With the mud density known, computer 20 may calculate, for example, hoop and other stresses for each Riser joint in the string.

It should be understood that computer 20 may calculate multiple solutions before reaching an optimal solution. Computer 20 may be programmed with assessment procedures and

Stress and Strain equations and approximations found in the literature, including but not limited, to the following references.

API 16F Section 5: Design

API 16F Section 17: Operation and Maintenance Manuals

API 16F Appendix A: Stress Analysis

API 16F Appendix B: Design for Static Loading

API 16F Appendix D: Bibliography

API 16Q Section 3: Riser Response Analysis

API 16Q Appendix B: Riser Analysis Data Worksheet

API 16Q Appendix D: Sample Riser Calculations

API 16Q Appendix F: References and Bibliography

API 579-1/ASME FFS-1 is herein below referred to as “API 579”

API 579 Section 2: Fitness-For-Service Engineering Assessment Procedures

API 579 Section 3: Assessment of Equipment for Brittle Fracture

API 579 Section 4: Assessment of General Metal Loss

API 579 Section 5: Assessment of Local Metal Loss

API 579 Section 6: Assessment of Pitting Corrosion

API 579 Section 7: Assessment of Blisters and Laminations

API 579 Section 8: Assessment of Weld Misalignment and Shell Distortion

API 579 Section 9: Assessment of Crack-Like-Flaws

API 579 Section 12: Assessment of Dents, Gouges and Dent-Gouge Combinations

API 579 Appendix B: Stress Analysis overview for a FFS Assessment

API 579 Appendix C: Compendium of Stress Intensity Factor Solutions

API 579 Appendix D: Compendium of Reference Stress Solutions

API 579 Appendix E: Residual Stress in Fitness-For-Service Evaluation

API 579 Appendix F: Material Properties for an FFS Assessment

API 579 Appendix G: Deterioration and Failure Modes

ASME B31.4 Chapter II Design

ASME B31.402 Calculation of Stresses

ASME B31.403 Criteria

ASME B31.4 Chapter VI Inspection and Testing

ASME B31.4 Chapter VII Operation and Maintenance Procedures

ASME B31.4 Chapter IX Offshore Liquid Pipeline Systems

As the water depth increases, Riser designs share the tension between the MT and the AUX, thus significantly complicating the RiserSEA. For example, sea currents bend the riser string as illustrated in FIG. 5A. When pipe bends, its major-axis is under tension and its minor-axis is under compression. In order to minimize the stored energy, the pipe assumes an oval shape, referred to as out-of-roundness or ovality. When the Loads are shared between the MT and the AUX, one of the AUX lines could be on the outside of MT's major axis (under higher tension) and one on the outside of MT's minor axis (under higher compression). In order to minimize those stresses, the Riser joint would tend to rotate in order to place the AUX in the neutral axis thus resulting in multidimensional stress. Furthermore, each AUX would also bend and thus it would undergo ovality under the influence of higher tension and compression. Therefore, RiserSEA must also translate the MT bending stresses to AUX multidimensional stresses corrected for the AUX material properties and geometry.

Scan the Riser—

Recognize Features and Deterioration Mechanism—

Apply time-depended deterioration mechanism correction factors resulting in updated inspection data.

Use the Formulas in FIGS. 3A and 3B to calculate Critical Deployment Parameters for each Riser joint using the updated inspection data.

Create a Riser string Model using the Critical Deployment Parameters of each Riser joint and calculate Critical Deployment Parameters for the Riser String.

Monitor Deployment Parameters and calculated Maximum Stresses.

Alarm if Maximum stresses exceed a preset Threshold.

Riser Fitness Certificate

As discussed earlier, FIG. 9A and FIG. 9B illustrates a fitness certificate, with FIG. 9B showing readings on, for example, riser 10. The certificate duration is set to 75% of the Riser estimated remaining useful life. Readings may be made for each of the pipes as indicated by MT, C, K and B (main tube 110, two choke and kill lines, 111, 111, booster line 112) wherein the nominal outer diameters and wall thickness are known. Various parameters are measured from each tube. FIG. 9B shows various information including a graph of the wall thickness profile for the main tube. The main tube is the main load bearing structure of the riser. The analysis may comprise use of the critically flawed path of FIG. 4.

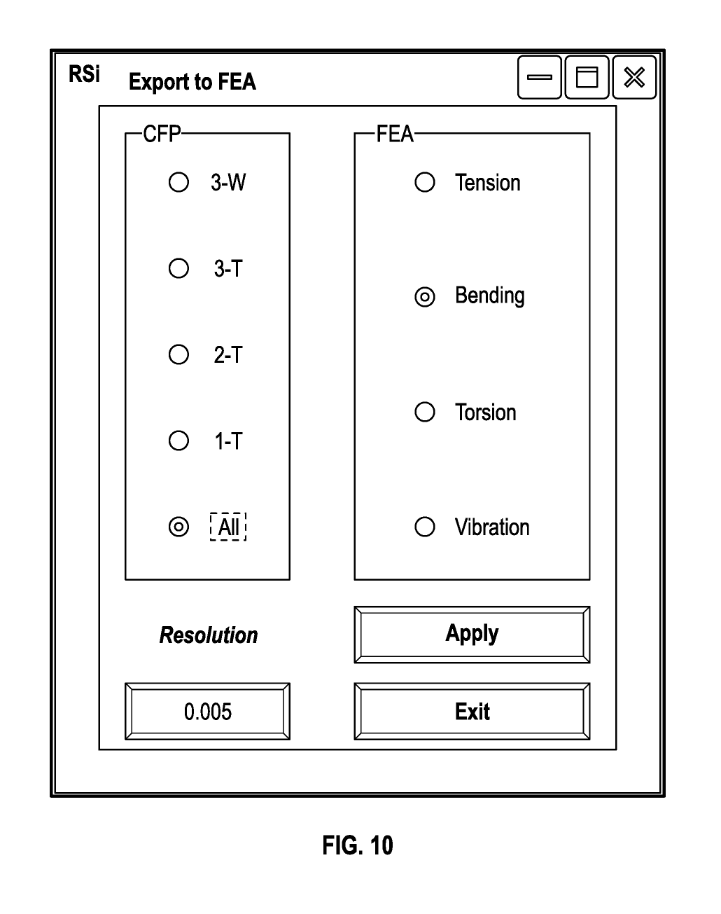

FIG. 10 shows export of measured data to an FEA engine screen is shown. A resolution is selected. A type of FEA analysis is selected. CFP refers to critically flawed path.

FIG. 10 shows a particular type of signals that may be produced by the system shown in FIG. 2 but the invention is not limited to particular types of signals but any signals produced in conjunction with such an analysis that are then used for export to an FEA machine. In this case, 3-W signals refers to signals related to thickness changes, tapers, rodwear, and so forth regarding general and local metal loss. 3-T signals refer to metallurgy, hardness changes, corrosion, pitting, critically flawed areas, and so forth. 2-T signals measure approximately ⅛ inch regarding local metal loss, pitting corrosion, blisters and laminations regarding pitting corrosion, crack-like flaws, and fatigue.

The various types of FEA analysis creates a theoretical string and subjects the theoretical string to various theoretical forces, e.g. bending, tension, torsion, and vibration, to test the theoretical string. However because the string is based on as-is measured values (rather than the values when manufactured) the analysis is representative of actual strings that have wear due to use as detected by the signals discussed above. The resolution is selected where smaller resolution requires longer FEA analysis.

A system of one or more computers can be configured to perform particular operations or actions by virtue of having software, firmware, hardware, or a combination of them installed on the system that in operation cause the system to perform the actions. One or more computer programs can be configured to perform particular operations or actions by virtue of including instructions that, when executed by data processing apparatus, cause the apparatus to perform the actions. One general aspect includes a riser assessment system of an as-is riser system including a riser string formed by a plurality of risers, each riser including a central tube and a plurality of peripheral tubes parallel to said central tube, including: a computer with storage, data entry, data readout and communication means; at least one sensor with an output in communication with said computer; a database; and calculation software to calculate maximum-stresses using said output to determine if said riser string is still fit-for-deployment or should be removed from deployment Other embodiments of this aspect include corresponding computer systems, apparatus, and computer programs recorded on one or more computer storage devices, each configured to perform the actions of the methods.

Implementations may include one or more of the following features. The riser assessment system where said riser features and properties include at least one of color, conductivity, corrosion, composition, crack-like-flaws, defects, deformation, depth, density, fatigue, flaws, geometry, geometric-distortion, groove-like-flaws, hardness, imperfections, metallurgy, misalignment, pit-like-flaws, reluctance, wall thickness, wear, weight, stress-concentrators, geometric stress amplifiers, similar items and combinations thereof. The riser assessment system where said loads include at least one of bending, buckling, compression, cyclic loading, deflection, deformation, depth, drilling induced vibration, dynamic linking, dynamic loading, eccentricity, eccentric loading, elastic deformation, energy absorption, feature growth, feature morphology migration, feature propagation, impulse, loading, misalignment, moments, offset, oscillation, plastic deformation, propagation, shear, static loading, recoil, strain, stress, tension, thermal loading, thickness, torsion, transient loading, twisting, vibration, vortex induced vibration, weight, any static, dynamic, transient and cyclic combinations thereof and similar items. The riser assessment system where said parameters include at least one of actions of drilling, actions of the environment, applied tension, biological, chemical, composition, depth, density, deterioration, dimensions, electrochemical, geometric dimensions and shape, mechanical, internal and external pressure, rig motion, sea currents, shape, waves, wind, weight of fluids and gases (drilling, production, control), yield strength combinations thereof and similar items. Implementations of the described techniques may include hardware, a method or process, or computer software on a computer-accessible medium.

In one embodiment, a finite-element-analysis system is provided that may comprise at least one computer, at least one material features acquisition system for the at least one computer, at least one memory storage for the at least one computer, wherein the at least one material feature can be stored, and a feature recognition program using at least one of algorithms, charts, equations, look-up tables and similar items stored in the at least one memory storage and executed by the at least one computer to perform at least one of detect, measure, distinguish, recognize, identify and connect the at least one material feature with known definitions and formulas stored in the at least one memory storage resulting in a one, two or three dimensional mathematical description of the at least one material feature. A finite element analysis program capable of a plurality of solutions is executed on the at least one computer to analyze the mathematical description of at least one material feature under a plurality of loads and deployment parameters.

The finite-element-analysis system may work many types of material including but not limited to at least one of aircraft, beam, bridge, blowout preventer, bop, boiler, cable, casing, chain, chiller, coiled tubing, chemical plant, column, composite, compressor, coupling, crane, drill pipe, drilling rig, enclosure, engine, fastener, flywheel, frame, gear, gear box, generator, girder, helicopter, hose, marine drilling and production riser, metal goods, oil country tubular goods, pipeline, piston, plate, power plant, propeller, pump, rail, refinery, rod, rolling stoke, sea going vessel, service rig, storage tank, structure, sucker rod, tensioner, train, transmission, trusses, tubing, turbine, vehicle, vessel, wheel, workover rig, subsystems of the above, components of the above, combinations of the above and similar items.

The material features may include but not be limited to at least one of balooning, blemish, blister, boxwear, coating, collar, corrosion, corrosion-band, coupling, crack, crack-like, critically-flawed-area, cfa, critically-flawed-path, cfp, chemistry, cross-sectional-area, csa, defect, deformation, dent, density, dimension, duration, eccentricity, erosion, fatigue, flaw, geometry, groove, groove-like, gauge, gauge-like, hardness, key-seat, lamination, loss-of-metallic-area, lma, metallic-area, mash, misalignment, neck-down, notch, ovality, paint, pit, pitting-band, pit-like, profile, proximity, rodwear, scratch, seam, sliver, straightness, stretch, surface-finish, surface-profile, taper, thickness, thread, threaded-connection, tool joint, wall, wall-thickness, wall-profile, wear, weld, wrinkles, a combination thereof and similar items.

The plurality of FEA solutions or theoretical loading comprise at least one of bending, buckling, compression, cyclic loading, deflection, deformation, dynamic linking, dynamic loading, eccentricity, eccentric loading, elastic deformation, energy absorption, feature growth, feature morphology migration, feature propagation, flexing, heave, impulse, loading, misalignment, moments, offset, oscillation, plastic deformation, pitch, propagation, pulsation, pulsating load, roll, shear, static loading, strain, stress, surge, sway, tension, thermal loading, torsion, twisting, vibration, yaw, analytical components of the above, relative components of the above, linear combinations thereof, non-linear combinations thereof, static combinations thereof, time-varying combinations thereof, transient combinations thereof and similar items.

The computer can be adapted to operate a data acquisition system to acquire and store in the memory storage deployment parameters of the material comprising but not being limited to at least one of absorption, AC parameters, acceleration, amplitude, angle, brittleness, capacitance, conductivity, color, coordinates, critical-point temperature, cyclic loading, DC parameters, deformation, density, depth, diameter, dimension, direction, distance, ductility, ductile-brittle transition temperature, eccentricity, eccentric loading, echo, flow, flow rate, fluid level, force, frequency, geometry, impedance, heave, horsepower, image, impedance, impulse, inductance, length, loads, load distribution, location, longitude, misalignment, moments, motion, number of cycles, number of rotations, number of strokes, opacity, ovality, penetration rate, permeability, ph, phase, plastic deformation, position, power, power consumption, pressure, propagation, proximity, radius, reflectivity, reluctance, resistance, rotation, rpm, shear, size, sound, specific gravity, speed, static loading, strain, stress, temperature, tension, thermal loading, torque, torsion, twisting, velocity, vibration, volume, wave, weight, weight on bit, width, relative values of the above, combinations of the above and similar items.

The at least one computer may also be adapted to operate a features acquisition system to acquire at least one of the plurality of features of the material. At least one sensor with an output is disposed about the material. The output comprises of signals indicative of at least one of the plurality of features, in a time-varying electrical form.

At least one sensor interface is utilized by the at least one computer, wherein the output is in communication with the at least one computer and wherein the at least one computer converts the signals to a digital format, producing digital signals that can be stored in the memory storage.

The system may be operable to induce an excitation into the material wherein the induction of excitation is controlled, at least in part, by the at least one computer and wherein an excitation response characteristic is stored in the memory storage of the at least one computer.

The output comprises, at least in part, a response of the material to the excitation.

In one embodiment, at least one database of features recognition equations stored in the memory storage; historical data of the material stored in the memory storage; at least one features recognition program being executed on the at least one computer and being guided by the at least one database to utilize the stored digital signals, equations and material historical data for identifying at least one of the plurality of the material features detected by the at least one sensor and to connect and associate the recognized at least one of the plurality of the material features with stored definitions, formulas and equations to convert the recognized material features into a description of the material for use by the finite element analysis program.

The system may further comprise at least one output device whereby an operator may examine at least one solution of the finite element analysis program, and at least one input device whereby an operator may modify, at least in part, he at least one description of the material and perform a finite element analysis on the modified description of the material, whereby the operator may examine a plurality of descriptions of the material analyzed by the finite element analysis program and may select at least one optimum material description from the plurality of descriptions. The material may be modified according to the optimized description.

A finite-element-analysis system can be used to optimize tubulars used in the exploration, drilling, production and transportation of hydrocarbons. In one embodiment, the system may comprise one or more of a computer, at least one material features acquisition system for the at least one computer, at least one memory storage for the at least one computer, wherein the at least one material feature can be stored, a feature recognition program using at least one of algorithms, charts, equations, look-up tables and similar items stored in the at least one memory storage and executed by the at least one computer to perform at least one of detect, measure, distinguish, recognize, identify and connect the at least one material feature with known definitions and formulas stored in the at least one memory storage resulting in a one, two or three dimensional mathematical description of the at least one material feature; and a finite element analysis program capable of a plurality of solutions, the program being executed on the at least one computer to analyze the mathematical description of at least one material feature under a plurality of loads and deployment parameters.

In another embodiment, the present invention may include a finite-element-analysis system to control Risk through Identification and Assessment followed by Corrective action and Monitoring in order to minimize the impact of unfortunate events and protect the public, the personnel, the environment and the property.

In another embodiment, a material optimization system is disclosed with at least one computer; at least one memory storage for the at least one computer, wherein the at least one description of the material can be stored, the description based on at least one of a plurality of the material variables; and a finite element analysis program capable of a plurality of solutions, the program being executed on the at least one computer to optimize the material the optimization based on the at least one of a plurality of the material variables.

The material to be assessed may include at least one of aircraft, beam, bridge, blowout preventer, bop, boiler, cable, casing, chain, chiller, coiled tubing, chemical plant, column, composite, compressor, coupling, crane, drill pipe, drilling rig, enclosure, engine, fastener, flywheel, frame, gear, gear box, generator, girder, helicopter, hose, marine drilling and production riser, metal goods, oil country tubular goods, pipeline, piston, power plant, propeller, pump, rail, refinery, rod, rolling stoke, sea going vessel, service rig, storage tank, structure, sucker rod, tensioner, train, transmission, trusses, tubing, turbine, vehicle, vessel, wheel, workover rig, sub-systems of the above, components of the above, combinations of the above, and similar items.

The material variables may comprise at least one of balooning, blemish, blister, boxwear, coating, collar, corrosion, corrosion-band, coupling, crack, crack-like, critically-flawed-area, cfa, critically-flawed-path, cfp, chemistry, cross-sectional-area, csa, defect, deformation, dent, density, dimension, duration, eccentricity, erosion, fatigue, flaw, geometry, groove, groove-like, gauge, gauge-like, hardness, key-seat, lamination, loss-of-metallic-area, lma, metal-lic-area, mash, misalignment, neck-down, notch, ovalty, paint, pit, pitting-band, pit-like, profile, proximity, rodwear, scratch, seam, sliver, straightness, stretch, surface-finish, surface-profile, taper, thickness, thread, threaded-connection, tool joint, wall, wall-thickness, wall-profile, wear, weld, wrinkles, a combination thereof and similar items.

The plurality of solutions comprise at least one of bending, buckling, compression, cyclic loading, deflection, deformation, dynamic linking, dynamic loading, eccentricity, eccentric loading, elastic deformation, energy absorption, feature growth, feature morphology migration, feature propagation, flexing, heave, impulse, loading, misalignment, moments, offset, oscillation, plastic deformation, pitch, propagation, pulsation, pulsating load, roll, shear, static loading, strain, stress, surge, sway, tension, thermal loading, torsion, twisting, vibration, yaw, analytical components of the above, relative components of the above, linear combinations thereof, non-linear combinations thereof, static combinations thereof, time-varying combinations thereof, transient combinations thereof and similar items.

The computer can be adapted to operate a data acquisition system to acquire and store in the memory storage deployment parameters of the material comprising at least one of absorption, AC parameters, acceleration, amplitude, angle, brittleness, capacitance, conductivity, color, coordinates, critical-point temperature, cyclic loading, DC parameters, deformation, density, depth, diameter, dimension, direction, distance, ductility, ductile-brittle transition temperature, eccentricity, eccentric loading, echo, flow, flow rate, fluid level, force, frequency, geometry, impedance, heave, horsepower, image, impedance, impulse, inductance, length, loads, load distribution, location, longitude, misalignment, moments, motion, number of cycles, number of rotations, number of strokes, opacity, ovality, penetration rate, permeability, ph, phase, plastic deformation, position, power, power consumption, pressure, propagation, proximity, radius, reflectivity, reluctance, resistance, rotation, rpm, shear, size, sound, specific gravity, speed, static loading, strain, stress, temperature, tension, thermal loading, torque, torsion, twisting, velocity, vibration, volume, wave, weight, weight on bit, width, relative values of the above, combinations of the above and similar items.

The at least one computer can be adapted to operate a variables acquisition system to acquire at least one of the plurality of variables of the material, comprising: at least one sensor with an output disposed about the material, the output comprising of signals indicative of at least one of the plurality of variables, in a time-varying electrical form; at least one sensor interface for the at least one computer, wherein the output is in communication with the at least one computer and wherein the at least one computer converts the signals to a digital format, producing digital signals; and wherein the digital signals can be stored in the memory storage.

The variables acquisition system is operable to induce an excitation into the material wherein the induction of excitation is controlled, at least in part, by the at least one computer and wherein an excitation response characteristic is stored in the memory storage of the at least one computer. The output comprises, at least in part, a response of the material to the excitation.

At least one database of variables recognition equations may be stored in the memory storage, historical data of the material may be stored in the memory storage; at least one variables recognition program may be executed on the at least one computer which is then guided by the at least one database to utilize the stored digital signals, equations and material historical data for identifying at least one of the plurality of the material variables detected by the at least one sensor and to connect and associate the recognized at least one of the plurality of the material variables with stored definitions, formulas and equations to convert the recognized material variables into a description of the material for use by the finite element analysis program.

At least one output device can be utilized whereby an operator may examine at least one solution of the finite element analysis program. At least one input device may be utilized whereby an operator may modify, at least in part, the at least one description of the material and perform a finite element analysis on the modified description of the material. The operator may examine a plurality of descriptions of the material analyzed by the finite element analysis program and may select at least one optimum material description from the plurality of descriptions whereby the material is modified according to the optimized description.

In another embodiment, a material optimization system to optimize tubulars used in the exploration, drilling, production and transportation of hydrocarbons comprising: at least one computer, at least one memory storage for the at least one computer, wherein the at least one description of the material can be stored, the description based on at least one of a plurality of the material variables; and a finite element analysis program capable of a plurality of solutions, the program being executed on the at least one computer to optimize the material the optimization based on the at least one of a plurality of the material variables.

A method may be provided for continuous engineering assessment, comprising producing an assessment of as-built material, utilizing at least one M×N addressable sensor cell with M×N sensors to produce FEA data representative of as-is material, producing a software simulation of the as-built material and a software simulation of the as-is material, and applying simulated forces to the software simulation of the as-is material software simulation of the as-built material, and comparing results of the step of applying the simulated forces.

In one embodiment, the present invention provides a material assessment system to assess a material comprising at least one computer, a material features acquisition system operable to detect a plurality of material features, a features recognition system operable to recognize the plurality of material features and to associate the recognized material features with known definitions, and software to operate upon the recognized material features to create a mathematical description of the material.

The material may include, but is not limited to, at least one of aircraft, beam, bridge, blowout preventer, bop, boiler, cable, casing, chain, chiller, coiled tubing, chemical plant, column, composite, compressor, coupling, crane, drill pipe, drilling rig, enclosure, engine, fastener, flywheel, frame, gear, gear box, generator, girder, helicopter, hose, marine drilling and production riser, metal goods, oil country tubular goods, pipeline, piston, power plant, propeller, pump, rail, refinery, rod, rolling stoke, sea going vessel, service rig, storage tank, structure, sucker rod, tensioner, train, transmission, trusses, tubing, turbine, vehicle, vessel, wheel, workover rig, components of the above, combinations of the above, and similar items.

The plurality of material features may include, but is not limited to, at least one of balooning, blemish, blister, boxwear, coating, collar, corrosion, corrosion-band, coupling, crack, crack-like, critically-flawed-area, cfa, critically-flawed-path, cfp, cross-sectional-area, csa, defect, deformation, dent, density, dimension, duration, eccentricity, erosion, fatigue, flaw, geometry, groove, groove-like, gauge, gauge-like, hardness, key-seat, lamination, loss-of-metallic-area, lma, metallic-area, mash, misalignment, neck-down, notch, ovality, paint, pit, pitting-band, pit-like, profile, proximity, rodwear, scratch, seam, sliver, straightness, stretch, surface-finish, surface-profile, taper, thickness, thread, threaded-connection, tool joint, wall, wall-thickness, wall-profile, wear, weld, wrinkles, a combination thereof and similar items.

The system may further include at least one sensor with an output comprising of signals indicative of plurality of features from the material under assessment, in a time-varying electrical form. A sensor interface may be provided for the at least one computer, wherein the output is in communication with the at least one computer and wherein the at least one computer converts the signals to a digital format, producing digital signals. A memory storage may be provided for the at least one computer to store the digital features.

The material features acquisition system may be operable to induce an excitation into the material under assessment wherein the induction of excitation is controlled, at least in part, by the at least one computer and wherein an excitation response characteristic is stored in the memory storage of the at least one computer.

The system may further include at least one database of material features recognition equations and material historical data stored in the memory storage. At least one program being executed on the at least one computer and being guided by the at least one database to utilize the stored digital signals, equations and material historical data for identifying the plurality of material features detected by the at least one sensor and to connect and associate the recognized material features with stored definitions, formulas and equations to convert the recognized material features into a mathematical description of the material under assessment.

The material features acquisition system may be adapted to operate a data acquisition system to acquire material deployment parameters including, but not limited to, at least one of absorption, AC parameters, acceleration, amplitude, angle, brittleness, capacitance, conductivity, color, critical-point temperature, cyclic loading, DC parameters, deformation, density, depth, diameter, dimension, direction, distance, ductility, ductile-brittle transition temperature, eccentricity, eccentric loading, echo, flow, flow rate, fluid level, force, frequency, geometry, impedance, heave, horsepower, image, impedance, impulse, inductance, length, loads, load distribution, location, longitude, misalignment, moments, motion, number of cycles, number of rotations, number of strokes, opacity, ovality, penetration rate, permeability, ph, phase, plastic deformation, position, power, power consumption, pressure, propagation, proximity, radius, reflectivity, reluctance, resistance, rotation, rpm, shear, size, sound, specific gravity, speed, static loading, strain, stress, temperature, tension, thermal loading, torque, torsion, twisting, velocity, vibration, volume, wave, weight, weight on bit, width, relative values of the above, combinations of the above and similar items.

The data acquisition system may be programmed to acquire loads endured by the material under assessment including at least one of bending, buckling, compression, cyclic loading, deflection, deformation, dynamic linking, dynamic loading, eccentricity, eccentric loading, elastic deformation, energy absorption, feature growth, feature morphology migration, feature propagation, flexing, heave, impulse, loading, misalignment, moments, offset, oscillation, plastic deformation, propagation, pulsation, pulsating load, shear, static loading, strain, stress, tension, thermal loading, torsion, twisting, vibration, analytical components of the above, relative components of the above, linear combinations thereof, non-linear combinations thereof and similar items.

The at least one computer may be programmed to apply at least one of the deployment parameters, loads or a combination thereof on the mathematical description of the material under assessment to calculate at least one of an as-is material, fitness for service, remaining useful life, remediation, and/or combinations thereof and similar items.

The material features may be partially obtained and inputted into the least one computer from a video camera in communication with the least one computer. In another embodiment, the identification of the material is partially obtained and inputted into the least one computer from a visual or an identification tag affixed onto or into the material under assessment. The material identification may be utilized to access stored historical data of the material under assessment.

The system may provide a speech synthesizer and at least one of a loudspeaker and an earphone, wherein the at least one computer requests a data input from an operator through natural speech.

The computer may inform the operator about the material under assessment status through natural speech.

A speech recognition engine and at least one microphone may be provided, wherein at least one of command, the material historical data, recognition and similar items is inputted at least in part into the least one computer by an operator through natural speech.

A sound recognition engine and at least one microphone, wherein at least one of the material deployment parameters, material historical data, loads and similar items is obtained at least in part from the sound recognition engine.

The system may further include a sound synthesizer and at least one of loudspeaker and earphone, wherein the computer converts the material status into audible sound.

The conversion of recognized plurality of material features into the mathematical description may further comprise a data format fit for use by a finite element analysis program or a computer aided design program or a combination of the above.

The conversion of the recognized plurality of material features may further comprise an operational model of the as-is material, the as-is material operational model being operated by the at least one computer, the operation guided by the at least one database to make at least one determination of whether the as-is material is functional as-designed, the as-is material is operating within the operational-envelop, the as-is material is fit for use for a service or should be removed from use in the service or a combination thereof.

The operation of the as-is material operational model may be operated by the at least one computer and the operation guided by the at least one database to determine a failure mode of the as-is material under at least one of the deployment parameters, the loads or combination thereof and to calculate a remediation to avert the failure.

In another embodiment of the present invention, a material assessment system is disclosed which may include, but is not limited to, at least one computer with storage, a material features acquisition system operable to detect a plurality of material features, a features recognition system operable to recognize a plurality of material features and to associate the recognized material features with known definitions, a database comprising of the material historical data stored in the storage, and software to operate upon the historical data and recognized material features to determine a change in the recognized material features and to store the change in the database of the material historical data.

The database may further comprise a plurality of risks, failure-chains, failure-modes and remediation of the material under assessment.

The at least one computer may be programmed to calculate a material change-chain using the stored historical data the calculation being guided by the database.

The at least one computer is further programmed to compare the material change-chain with the plurality of risks, failure-chains and/or failure-modes, the calculation being guided by the database, to determine if the material change-chain matches an early stage of at least one of the risks, plurality of failure-chains and/or failure-modes and to recommend a remediation to disrupt the evolution of the change-chain into a failure-chain.

Another embodiment discloses a method to disrupt at least one failure-chain, including the steps of analyzing a system utilizing system risks and failure chains and at least one of system historical data, loads, deployment parameters, environment, to define the system operational-envelop, reducing the system into sub-systems and components, and analyzing the sub-systems and components utilizing subsystem and component risks and failure-chains and at least one of subsystem and components historical data, loads, deployment parameters, environment, to define the sub-systems and components operational-envelop. The components are assessed to determine the as-is components and the as-is components are assessed on an ongoing basis to calculate changes in the as-is components. Further steps include assessing the sub-systems to determine the as-is sub-systems using the as-is components and assessing the as-is subsystem to calculate changes in the as-is sub-systems, assessing the system to determine the an as-is system using the as-is sub-systems and as-is components and assessing the as-is system to calculate changes in the as-is system, and identifying and remediating at least one of the system risks and failure-chains and at least one of the subsystem and components risks and failure-chains associated with at least one of the changes, thereby disrupting the at least one failure-chain.

The method may further comprise calculating at least one of a fitness for service, remaining useful life or a combination thereof.

In another embodiment, a continuous vigilance sensor cell to monitor a material is disclosed including an M×N array of addressable sensors positioned adjacent the material, operators for the sensor cell to receive signals from selected of the addressable sensors and combine data to produce virtual sensor data, and at least one computer to control addressing and use of the operators to produce the virtual sensor data.

In other embodiments, a method for optimizing materials for use is shown including the steps of inducing an excitation into the material and detecting the response of the material to the excitation with at least one sensor with an output signal in a time-varying electrical form. The output signal is then communicated to at least one computer with memory storage and the signal converted to a digital format resulting in a digital signal stored in the memory storage. Further steps include inputting and storing in the memory storage at least one set of recognition equations and historical data of the material, inputting at least one set of constrains into the at least one computer, wherein the at least one set of constrains are evaluated by the at least one computer for recognizing the types of imperfections detected by the at least one imperfection detection sensor, and finally storing the at least one set of constrains and/or the output into at least one memory storage.

Recognizing the types of imperfections may further comprise at least one mathematical array of coefficients, wherein the coefficients comprise converted and/or decomposed signals from the at least one imperfection detection sensor, and/or baseline data comprising data from known material imperfection, and/or historical data comprising data previously gathered from the material being inspected, wherein the converted at least one imperfection signal is processed by the at least one computer using a mathematical array of coefficients and constants. The coefficients comprise converted signals from the at least one imperfection detection sensor, and wherein the constants are derived, at least in part, from baseline data comprising data from known material imperfection, and/or historical data comprising data previously gathered from the material being inspected.

The at least one memory storage may also be the at least one computer.

The at least one memory storage may comprise more than one memory storage, and the at least one imperfection detection sensor may comprise a memory storage.

The method may further comprise the step of developing the coefficients including inputting parameters associated with a material being inspected into a database. The parameters may comprise physical characteristics of the material being inspected.

The processing of the converted at least one imperfection signals by the at least one computer may further comprise scaling the converted at least one imperfection signals, wherein the scaling accounts for variations in testing parameters, decomposing the converted at least one imperfection signals which separates the converted at least one imperfection signals into components indicative of various imperfections, and generating identifiers by fusing the decomposed signal with parameters and/or database data and/or historical data associated with the material being inspected.

The identifiers may provide a prediction of the type of imperfection.

The method may further comprise searching a database of prior information and/or identifiers, relating to the material being inspected, to implement an imperfection identification.

The at least one computer may analyze the database of prior information and the identifiers to assign a preliminary determination of the imperfection.

The preliminary determination may be compared to baseline data comprising data from known material imperfection, and/or historical data comprising data previously gathered from the material being inspected to resolve conflicting determination of the imperfection.

The resolving of conflicting determination of the imperfection may include as-signing a determination based on the substantial criticality of the imperfection to the material being inspected, a re-evaluation and resolution of the conflicting determination of the imperfection, and coding and storing new data in a decomposed signals database.

In other embodiments, a method to recognize imperfections in materials is disclosed including, but not limited to, operating an imperfection detection sensor which emits an electronic signal regarding an element to be inspected, band limiting the electronic signal which comprises passing the electronic signal through at least one filter, scaling the electronic signal to account for variations in testing parameters, converting the electronic signal into a digital signal, and inputting the digital signal into at least one computer. Further steps include de-noising the digital signal, wherein the de-noising comprises separation and/or removal of a component of the digital signal, decomposing the digital signal into components indicative of various imperfections, calculating at least one first identifier from the components indicative of various imperfections, wherein the calculating is performed by the at least one computer, comparing the at least one first identifier to a pre-established identifier, wherein the pre-established identifier is stored in a pre-established database, and recognizing an imperfection from the comparison, wherein the recognition is performed by the at least one computer and is stored in the pre-established database and/or outputted from the at least one computer.

The method may further comprise the step of resolving a recognition conflict.

The method may further comprise the step of resolving an instability in the recognition of the imperfection, wherein instability comprises recognizing more than one imperfection during the comparison.

The method may further comprise the step of inducing an excitation into a material and detecting the response of the excitation through the imperfection detection sensor; wherein the inducing of the excitation is controlled by the at least one computer.

In another embodiments, a method to inspect materials for locating desired characteristics is provided, including, but not limited to, operating an imperfection detection sensor which emits an electronic signal regarding an element to be inspected, band limiting the electronic signal which comprises passing the electronic signal through at least one filter, scaling the electronic signal to account for variations in testing parameters, converting the electronic signal into a digital signal, and inputting the digital signal into at least one computer. Further steps include de-noising the digital signal, wherein the de-noising comprises separation and/or removal of a component of the digital signal, decomposing the digital signal into components indicative of various imperfections, calculating at least one first identifier from the components indicative of various imperfections, wherein the calculating is performed by the at least one computer, comparing the at least one first identifier to a pre-established identifier, wherein the pre-established identifier is stored in a pre-established database, and recognizing an imperfection from the comparison, wherein the recognition is performed by the at least one computer and is stored in the pre-established database and/or outputted from the at least one computer.

The method may further comprise the step of resolving a recognition conflict

The method may further comprise the step of resolving an instability in the recognition of the imperfection, wherein instability comprises recognizing more than one imperfection during the comparison.

The method may further comprise the step of inducing an excitation into a material and detecting the response of the excitation through the imperfection detection sensor; wherein the inducing of the excitation is controlled by the at least one computer.

Another embodiment provides for a material assessment system comprising at least one computer, a material features acquisition system operable to detect a plurality of material features, a features recognition system operable to recognize a plurality of material features and to associate the recognized material features with known definitions, and software to operate upon the recognized material features to create a mathematical description of the material under assessment.

The material may comprise at least one of aircraft, beam, bridge, blowout preventer, bop, boiler, cable, casing, chain, chiller, coiled tubing, chemical plant, column, composite, compressor, coupling, crane, drill pipe, drilling rig, enclosure, engine, fastener, flywheel, frame, gear, gear box, generator, girder, helicopter, hose, marine drilling and production riser, metal goods, oil country tubular goods, pipeline, piston, power plant, propeller, pump, rail, refinery, rod, rolling stoke, sea going vessel, service rig, storage tank, structure, sucker rod, tensioner, train, transmission, trusses, tubing, turbine, vehicle, vessel, wheel, workover rig, subsystems of the above, components of the above, combinations of the above, and similar items.

The material features may include at least one of balooning, blemish, blister, boxwear, coating, collar, corrosion, corrosion-band, coupling, crack, crack-like, critically-flawed-area, cfa, critically-flawed-path, cfp, cross-sectional-area, csa, defect, deformation, dent, density, dimension, duration, eccentricity, erosion, fatigue, flaw, geometry, groove, groove-like, gauge, gauge-like, hardness, key-seat, lamination, loss-of-metallic-area, lma, metallic-area, mash, misalignment, neck-down, notch, ovality, paint, pit, pitting-band, pit-like, profile, proximity, rodwear, scratch, seam, sliver, straightness, stretch, surface-finish, surface-profile, taper, thickness, thread, threaded-connection, tool joint, wall, wall-thickness, wall-profile, wear, weld, wrinkles, a combination thereof and similar items.

The system may further include at least one sensor with an output comprising of signals indicative of plurality of features from the material under assessment, in a time-varying electrical form. A sensor interface may be provided for the at least one computer, wherein the output is in communication with the at least one computer and wherein the at least one computer converts the signals to a digital format, producing digital signals. A memory storage may be provided for the at least one computer to store the digital features.

The material features acquisition system may be operable to induce an excitation into the material under assessment wherein the induction of excitation is controlled, at least in part, by the at least one computer and wherein an excitation response characteristic is stored in the memory storage of the at least one computer.

The output may comprise at least in part a response of the material under assessment to the excitation.

The system may further include at least one database of material features recognition equations and material historical data stored in the memory storage. At least one program being executed on the at least one computer and being guided by the at least one database to utilize the stored digital signals, equations and material historical data for identifying the plurality of material features detected by the at least one sensor and to connect and associate the recognized material features with stored definitions, formulas and equations to convert the recognized material features into a mathematical description of the material under assessment.

The material features acquisition system may be adapted to operate a data acquisition system to acquire material deployment parameters including, but not limited to, at least one of absorption, AC parameters, acceleration, amplitude, angle, brittleness, capacitance, conductivity, color, critical-point temperature, cyclic loading, DC parameters, deformation, density, depth, diameter, dimension, direction, distance, ductility, ductile-brittle transition temperature, eccentricity, eccentric loading, echo, flow, flow rate, fluid level, force, frequency, geometry, impedance, heave, horsepower, image, impedance, impulse, inductance, length, loads, load distribution, location, longitude, misalignment, moments, motion, number of cycles, number of rotations, number of strokes, opacity, ovality, penetration rate, permeability, ph, phase, plastic deformation, position, power, power consumption, pressure, propagation, proximity, radius, reflectivity, reluctance, resistance, rotation, rpm, shear, size, sound, specific gravity, speed, static loading, strain, stress, temperature, tension, thermal loading, torque, torsion, twisting, velocity, vibration, volume, wave, weight, weight on bit, width, relative values of the above, combinations of the above and similar items.

The data acquisition system may be programmed to acquire loads endured by the material under assessment including at least one of bending, buckling, compression, cyclic loading, deflection, deformation, dynamic linking, dynamic loading, eccentricity, eccentric loading, elastic deformation, energy absorption, feature growth, feature morphology migration, feature propagation, flexing, heave, impulse, loading, misalignment, moments, offset, oscillation, plastic deformation, propagation, pulsation, pulsating load, shear, static loading, strain, stress, tension, thermal loading, torsion, twisting, vibration, analytical components of the above, relative components of the above, linear combinations thereof, non-linear combinations thereof and similar items.

The at least one computer may be programmed to apply at least one of the deployment parameters, loads or a combination thereof on the mathematical description of the material under assessment to calculate at least one of an as-is material, fitness for service, remaining useful life, remediation, and/or combinations thereof and similar items.

The calculation may further comprise of at least one of axial stress, burst yield, collapse yield, fluid volume, hoop stress, overpull, radial stress, stretch, ultimate load capacity, ultimate torque, yield load capacity, yield torque, similar items and combination thereof.

The calculation further determines an effect that at least one of the recognized material feature has upon another of the recognized material feature.

The material features may be partially obtained and inputted into the least one computer from a video camera in communication with the least one computer.

The identification of the material may be partially obtained and inputted into the least one computer from a visual or an identification tag affixed onto or into the material under assessment.

The material identification may be utilized to access stored historical data of the material under assessment.

The system may further include a speech synthesizer and at least one of loudspeaker and/or earphone and/or a speech emanating device, wherein the at least one computer requests a data input from an operator through natural speech.

The computer may inform the operator about the material under assessment status through natural speech.

The inspection system may include at least one language selector, wherein the speech synthesizer produces voice output in more than one language.

The inspection system may further include a speech recognition engine and at least one of microphone and/or electroacoustic device, wherein at least one of command, the material historical data, recognition and similar items is inputted at least in part into the least one computer by an operator through natural speech.

The inspection system may include at least one language selector, wherein the speech recognition engine may accept and recognize more than one language.

The inspection system may include an automatic language selector, wherein the speech recognition engine may automatically accept and recognize more than one language.

The inspection system may include an automatic language selector, wherein the speech recognition engine may automatically and substantially simultaneously recognize more than one language.

The inspection system may further comprise at least one of a fingerprint, voiceprint, iris scan, face recognition and other biometric identification capability to recognize an operator.

The inspection system may include a sound recognition engine and at least one of microphone and/or electroacoustic device, wherein at least one of the material deployment parameters, the material historical data, the loads, the deployment parameters and similar items is obtained at least in part from the sound recognition engine.

A sound synthesizer and at least one of loudspeaker and/or earphone and/or a speech emanating device may be provided so the computer converts the material under assessment status into audible sound.

The conversion of recognized plurality of material features into the mathematical description may comprise a data format fit for use by a finite element analysis program and/or a computer aided design program and/or another program or a combination of the above. It may also further comprise an operational model of the as-is material under assessment, the as-is material under assessment operational model being operated by the at least one computer, the operation guided by the at least one database to make at least one determination of whether the as-is material under assessment is functional as-designed, the as-is material under assessment is operating within the operational-envelop, the as-is material under assessment is fit for use for a service or should be removed from use in the service or a combination thereof.

The operation of the as-is material under assessment operational model may be operated by the at least one computer and the operation guided by the at least one database to determine a failure mode of the as-is material under at least one of the deployment parameters, the loads or combination thereof and to calculate a remediation to avert the failure.

The at least one computer may be programmed to calculate at least one change in at least one of the recognized features comprising of a difference, a feature change, a feature morphology migration, a feature morphology shift, a feature propagation, a coverage change, combinations thereof and similar items utilizing, at least in part, the material under assessment stored historical data.

The at least one computer may compare at least one of the material under assessment change with a plurality of failure-chains stored in the material under assessment historical data to determine a match indicative of an evolution of a failure-chain.

The at least one computer may recommend remediation to disrupt the evolution of the failure-chain. The remediation may comprise at least one of utilization, redeployment and alteration to a shape of at least one of the recognized material features.

The at least one computer may be programmed to calculate at least one change in at least one of the loads and the deployment parameters to correlate and/or associate and/or connect at least in part, with the change in at least one of the recognized features utilizing, at least in part, the material under assessment stored historical data.

The at least one computer may be programmed to calculate at least one sensitivity in at least one of the recognized material features to the loads and/or the deployment parameters change.

The location of the material recognized features is in reference to the at least one sensor.

The at least one computer may calculates the location of at least one of the material recognized features in reference to other locations utilizing the deployment parameters and the historical data.

The system may comprise at least one communication link. The at least one communication link may include, but is not limited to, at least one of a radio, a wireless, sonic, underwater modem, other types of communicators, chain or relay stations, a combination thereof and similar items. The communication link may provide bidirectional access to the material assessment system whereby the material assessment system may be monitored and/or controlled from a remote location.

Another embodiment may provide a material assessment system comprising, but not limited to, at least one computer with storage, a material features acquisition system operable to detect a plurality of material features, a features recognition system operable to recognize a plurality of material features and to associate the recognized material features with known definitions, a database comprising of the material historical data stored in the storage, and software to operate upon the historical data and recognized material features to determine a change in the recognized material features and to store the change in the database of the material historical data.

The database may further comprise at least one of a risk, failure-chain, failure-mode, sensitivity of failure-chain to change, sensitivity of failure-chain to initial conditions, remediation, combinations of the above and similar items of the material under assessment.

The at least one computer may be programmed to calculate a material change-chain using the stored historical data the calculation being guided by the database.

The at least one computer may be further programmed to compare the material change-chain with the at least one of risk and/or failure-chain and/or failure-mode, the comparison being guided by the database, to determine if the material change-chain matches an early stage of at least one of the risk and/or failure-chain and/or failure-mode and to recommend a remediation to disrupt the evolution of the change-chain into a failure-chain.

In another embodiment, a method to disrupt at least one failure-chain is provided including the steps of analyzing a system utilizing system risks and failure-chains and at least one of system historical data, loads, deployment parameters and environment to define system operational-envelop, reducing the system into subsystems and components, analyzing the subsystems and components utilizing subsystem and component risks and failure-chains and at least one of subsystem and component historical data, loads, deployment parameters and environment to define the subsystems and components operational-envelop, assessing the components to determine as-is components and assessing the as-is components on an ongoing basis to calculate changes in the as-is components, assessing the subsystems to determine as-is subsystems using the as-is components and assessing the as-is subsystems on an ongoing basis to calculate changes in the as-is subsystems, assessing the system to determine an as-is system using the as-is subsystems and as-is components and assessing the as-is system on an ongoing basis to calculate changes in the as-is system, and identifying and remediating at least one of the system risks and failure-chains and at least one of the subsystem and component risks and failure-chains associated with at least one of the changes to disrupt the at least one failure-chain.

The method may further comprise calculating at least one of a fitness for service, remaining useful life or a combination thereof

In another embodiment, a material assessment system is provided, comprising at least one computer, an operable material software model stored in the at least one computer, a material features acquisition system operable to detect a plurality of material features, a parameters and loads acquisition system operable to detect a plurality of parameters and loads endured by the material, a database comprising at least one of material utilization constraints and material historical data, a features recognition system operable to recognize a plurality of material features and to associate the recognized material features with known definitions, a model update system to translate the recognized material features under the plurality of parameters, loads and utilization constraints to update the material software model, and a constant vigilance system to operate the material software model to determine a status of the material.

In yet another embodiment, a material assessment system is provided for comprising at least one computer, a material features acquisition system operable to detect a plurality of material features, a features recognition system operable to recognize a plurality of material features and to associate the recognized material features with known definitions, and software to operate upon the recognized material features to create a mathematical description of the material.

The material features may comprise at least one of balooning, blemish, blister, boxwear, coating, collar, corrosion, corrosion-band, coupling, crack, crack-like, critically-flawed-area, cross-sectional-area, defect, deformation, dent, density, CSA, dimension, duration, eccentricity, erosion, fatigue, flaw, geometry, groove, groove-like, gauge, gauge-like, hardness, key-seat, lamination, loss-of-metallic-area, LMA, metallic-area, mash, misalignment, neck-down, notch, ovality, paint, pit, pitting-band, pit-like, profile, proximity, rodwear, scratch, seam, sliver, straightness, taper, thickness, thread, threaded-connection, tool joint, wall, wall-thickness, wall-profile, wear, weld, wrinkles, a combination thereof and similar items.

The parameters may comprise at least one of acceleration, capacitance, conductivity, color, density, dimension, distance, flow, force, frequency, horsepower, heave, image, inductance, intensity, interference, length, level, loading, load distribution, Loads measurement, number of cycles, number of rotations, number of strokes, opacity, penetration rate, permeability, ph, position, power, power consumption, pressure, proximity, reflectivity, reluctance, resistance, rotation, temperature, time, specific gravity, strain, tension, torque, velocity, volume, weight and combinations of the above and similar items.

The loads may comprise at least one of bending, buckling, compression, cyclic loading, deflection, deformation, dynamic linking, dynamic loading, eccentricity, eccentric loading, elastic deformation, energy absorption, Feature growth, Feature morphology migration, Feature propagation, impulse, loading, misalignment, moments, offset, oscillation, plastic deformation, propagation, shear, static loading, strain, stress, tension, thermal loading, torsion, twisting, vibration, combinations thereof and similar items.

The assessment system of claim 99, further comprising a speech synthesizer and at least one of loudspeaker and earphone, wherein the at least one computer requests input of at least one of the constraints and material historical data from an operator through natural speech. The computer may inform the operator about the material status through natural speech.

A speech recognition engine and at least one microphone may be provided where at least one of the constraints and material historical data is inputted at least in part into the least one computer by an operator through natural speech.

The system may include a sound recognition engine and at least one microphone, wherein at least one of the constraints and material historical data is obtained at least in part from the sound recognition engine.

A sound synthesizer and at least one of loudspeaker and earphone may be included so the computer may convert the material status into audible sound.

The material features may be partially obtained and inputted into the least one computer from a video camera in communication with the least one computer. The material may be partially obtained and inputted into the least one computer from a visual or electromagnetic identification tag affixed onto or into the material.

The material utilization constraints may further comprise at least one of coefficients, rules, knowledge and data developed and inputted into the at least one computer prior to the assessment of the material.

In yet another embodiment, a method to evaluate material is disclosed comprising detecting physical phenomena in an environment in which a material under evaluation is utilized, scanning the material under evaluation to detect material features, and programming a computer to utilize digital signals produced in response to the detecting and the scanning to calculate a remaining useful life of the material under evaluation.

Another embodiment of the present invention discloses a method to evaluate material including, but not limited to, the steps of repeatedly scanning a material under evaluation over time to detect new material features and monitor previously detected material features, and programming a computer to analyze data produced during the step of repeatedly scanning to determine at least one degradation mechanism from a plurality of possible degradation mechanisms affecting the material under evaluation from a plurality.

Another step may comprise programming the computer to recommend a preventative action to inhibit the at least one degradation mechanism.

It may be seen from the preceding description that a novel stress engineering assessment system has been provided. Although specific examples may have been described and disclosed, the invention of the instant application is considered to comprise and is intended to comprise any equivalent structure and may be constructed in many different ways to function and operate in the general manner as explained hereinbefore. Accordingly, it is noted that the embodiments described herein in detail for exemplary purposes are of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. A method for assessment of an as-is riser system comprising a riser string comprising a plurality of risers, each riser comprising a central tube and a plurality of peripheral tubes parallel to said central tube, comprising:
running a surveying tool individually through said central tube and said plurality of peripheral tubes for each riser of said plurality of risers to produce survey data;
transferring said survey data for each of said plurality of risers to a finite element analysis program;
utilizing said finite element analysis program to combine said plurality of risers into a simulated riser string;
selecting and then applying simulated loads to said simulated riser string and determining whether said simulated riser is fit for use with said simulated loads; and
using said simulated loads and said simulated riser string to assess said as-is riser system.

2. The method of claim 1, further comprising:
keeping track of an order of each riser with respect to each other for said plurality of risers,
simulating a change in an order of said plurality of risers to provide a re-ordered simulated riser string, and
selecting and applying said simulated loads to said re-ordered simulated riser string and determining whether said re-ordered simulated riser is operable to withstand said simulated loads.

3. The method of claim 2, further comprising:
replacing selected of said plurality of risers from said simulated riser string and determining whether said re-ordered simulated riser string is operable to withstand said simulated loads.

4. The method of claim 1, wherein said simulated loads comprise at least two of tension, bending, torsion, and vibration.

5. The method of claim 1, further comprising determining which of said plurality of risers is a weakest riser.

6. The method of claim 1, further comprising maximum riser stresses during deployment.

7. The method of claim 6, further comprising utilizing deployment data along with riser material and geometry data.

8. The method of claim 1, further comprising including an effect of a geometric stress amplifiers, and comparing stresses to failure criteria to determine if the riser string is still fit-for-deployment.

9. The method of claim 1, wherein said simulated loads comprise vortex induced vibration.

10. The method of claim 1 utilizing definitions and formulas stored in at least one memory storage resulting in a one, two or three dimensional mathematical description of said simulated loads and said simulated riser string to assess said as-is riser system.

11. A riser assessment system of an as-is riser system comprising a riser string formed by a plurality of risers, each riser comprising a central tube and a plurality of peripheral tubes parallel to said central tube, comprising:
a computer with storage, data entry, data readout and communication means;
at least one sensor with an output in communication with said computer;
a database; and
calculation software to calculate maximum-stresses using said output to determine if said riser string is still fit-for-deployment or should be removed from deployment.

12. The riser assessment system of claim 11 wherein said output comprises at least one of riser features or loads.

13. The riser assessment system of claim 12 wherein said riser features comprise at least one of flaws comprising cracks, deformation, geometric-distortion, and wall thickness and combinations thereof.

14. The Riser assessment system of claim 12 wherein said loads comprise at least one of bending, tension, torsion, and vibration.

15. The riser assessment system of claim 12, further comprising said output comprises parameters wherein said parameters comprise at least one of actions of drilling, actions of the environment, rig motion, sea currents, weight of drilling fluids.

16. The riser assessment system of claim 12, further comprising a natural language input for said at least one computer for said data entry or to control said calculation software.
